(19) United States
(12) Patent Application Publication
(10) Pub. No.: US 2016/0083623 A1
(43) Pub. Date: Mar. 24, 2016

(54) Method for Immersion Paint Coating Electrically Conductive Substrates While Post-Treating the Immersion Paint Coating with an Aqueous Sol-Gel Composition Prior to Curing the Coating

(71) Applicants: BASF COATINGS GMBH, Münster (DE); HENKEL AG & CO. KGAA, Düsseldorf (DE)

(72) Inventors: Katrin Wczasek, Duesseldorf (DE); Sebastian Sinnwell, Duesseldorf (DE); Rolf Schulte, Havixbeck (DE); Ute Herrmann, Wuppertal (DE)

(21) Appl. No.: 14/892,229

(22) PCT Filed: May 28, 2014
(86) PCT No.: PCT/EP2014/061109

§ 371 Date: Nov. 19, 2015

(30) Foreign Application Priority Data
May 28, 2013 (EP) 13169510.8

(51) Int. Cl. C09D 183/06; C25D 13/06

(52) U.S. Cl. CPC C09D 183/06; C25D 13/06

(57) ABSTRACT

The present invention relates to a method for at least partly coating an electrically conductive substrate, comprising at least the steps of (1): at least partly coating the substrate with a dipping varnish comprising at least one binder, by at least partial electrophoretic deposition of the dipping varnish on the substrate surface, and (2): contacting the substrate at least partly coated with the dipping varnish with an aqueous composition, where the aqueous composition used in step (2) is an aqueous sol-gel composition and step (2) takes place before curing of the electrophoretically deposited dipping varnish, to an at least partly coated substrate obtainable by this method, and to the use of an aqueous sol-gel composition for aftertreating a dipping varnish layer applied at least partly to an electrically conductive substrate by an at least partial electrophoretic deposition.

The present invention relates to a method for at least partly coating an electrically conductive substrate, comprising at least the steps of (1): at least partly coating the substrate with a dipping varnish comprising at least one binder, by at least partial electrophoretic deposition of the dipping varnish on the substrate surface, and (2): contacting the substrate at least partly coated with the dipping varnish with an aqueous composition, where the aqueous composition used in step (2) is an aqueous sol-gel composition and step (2) takes place before curing of the electrophoretically deposited dipping varnish, to an at least partly coated substrate obtainable by this method, and to the use of an aqueous sol-gel composition for aftertreating a dipping varnish layer applied at least partly to an electrically conductive substrate by an at least partial electrophoretic deposition.

In the automobile segment, the metallic components used for the manufacture must customarily be protected against corrosion, since the requirements with regard to the corrosion control that is to be achieved are very high, not least because the manufacturers often offer a guarantee against rust perforation for many years. Such corrosion control is customarily achieved through the coating of the components, or of the substrates used to make them, with at least one coating suitable for that purpose.

CN 101 538 711 B discloses substrates to which, following electrophoretic deposition of cobalt ferrite, a layer based on barium titanate is applied. CN 101 787 553 A discloses substrates to which, following electrophoretic deposition of a lead magnesium niobate titanate, a layer based on lead oxide is applied. The compositions used for the electrophoretic deposition in each case contain no binders. The compositions used for coating with barium titanate and with lead oxide, respectively, are nonaqueous. Prior to the barium titanate coating, according to CN 101 538 711 B, heating takes place at 600-700° C. over a time of 30-60 minutes.

WO 2006/019803 A2 discloses a method for coating a metallic substrate which is coated, following electrophoretic coating with a siloxane-containing composition such as a polysiloxane, i.e., a polymerization product of siloxanes wherein the hydrogen radicals of the siloxanes have each been replaced by organic radicals. References to sol-gel compositions are not contained in WO 2006/019803 A2.

A disadvantage of the known coating methods, particularly affecting the known methods employed in the automobile industry, is that these methods customarily envision a phosphating pretreatment step wherein the substrate for coating, following an optional cleaning step and prior to a dip coating step, is treated with a metal phosphate such as zinc phosphate in a phosphating step in order to ensure sufficient corrosion control. This pretreatment customarily entails the implementation of a plurality of method steps in a plurality of different dip tanks with different heating. Implementing a pretreatment of this kind, moreover, entails production of waste sludges, which burden the environment and must be disposed of. For financial and environmental reasons in particular, therefore, it is desirable to be able to save on such pretreatment steps, but nevertheless to achieve the same corrosion control effect as that achieved with the known methods.

An aftertreatment of substrates provided with a coating, such as with a dipping varnish, in a first method step, by rinsing these substrates with an aqueous composition comprising colloidal oxides or colloidal hydroxides of a metal of atomic number 20 to 83, is known from EP 1 510 558 A1, for example. However, it is difficult to apply such colloidal metal oxides and metal hydroxides to a coating, particularly since with such metal oxides and metal hydroxides it is impossible to form a film or to form any covalent bonds with binder and optionally crosslinking agent present in the dipping varnish.

Aftertreatment of substrates provided with a coating in a first method step, by rinsing them with a composition comprising one or more of the elements yttrium, titanium, and metals from the group of the rare earths, is known from WO 03/090938 A1. The corrosion control effect of the coated substrates obtained by means of the method described therein is limited, however, to a few metallic substrates such as steel. For financial reasons, moreover, there is no advantage in using rare earths in industrial operations such as the painting of automobile bodies or corresponding parts. Furthermore, the compositions disclosed in WO 03/090938 A1 are also difficult to apply to a coating, since with these compositions as well it is not possible to form a film or to form any covalent bonds with binder and optionally crosslinking agent present in the dipping varnish.

There is therefore a need for a method for at least partly coating an electrically conductive substrate that can be implemented more economically and eco-friendly than the known methods, yet is at least equally suitable for obtaining the required corrosion control effect.

It is an object of the present invention, therefore, to provide a method for at least partly coating an electrically conductive substrate that has advantages over the method known from the prior art. A particular object of the present invention is to provide a method which removes the need for the phosphating which is customarily carried out with a metal phosphate prior to dip coating, yet can be used nevertheless to achieve at least the same corrosion control effect that can also be achieved with the customary methods.

This object is achieved by means of a method for at least partly coating an electrically conductive substrate, comprising at least the steps of
(1) at least partly coating the substrate with a dipping varnish comprising at least one binder, by at least partial electrophoretic deposition of the dipping varnish on the substrate surface, and
(2) contacting the substrate at least partly coated with the dipping varnish with an aqueous composition,
wherein the aqueous composition used in step (2) is an aqueous sol-gel composition, and
step (2) takes place before curing of the electrophoretically deposited dipping varnish.

It has surprisingly been found that the method of the invention obviates the required step that must customarily be carried out prior to dip coating, namely the step of pretreating the electrically conductive substrate for at least partial coating with a metal phosphate such as zinc phosphate to form a metal phosphate coat on the substrate, and in so doing allows the method overall to be made not only more economic, in particular less time-consuming and cost-intensive, but also more eco-friendly than conventional methods.

In particular it has surprisingly been found that the at least partly coated substrates produced by means of the method of the invention encompassing at least steps (1) and (2) have at least no disadvantages, and in particular have advantages in terms of the corrosion control effect of the coatings, not least by virtue of the contacting in step (2), in comparison to substrates obtained by conventional methods that have no step (2): accordingly, the coated substrates produced by means of the method of the invention, more particularly coated galvanized steels and aluminum, are distinguished relative to corresponding comparative examples by the fact in particular that the subfilm migration—as a measure of corrosion control effect—is significantly less in the case of the coated substrates produced by means of the method of the invention encompassing, in particular, step (2).

The method of the invention is preferably a method for at least partly coating an electrically conductive substrate used in and/or for automaking. The method may take place continuously, such as in a coil-coating process, for example, or discontinuously.

Suitable electrically conductive substrates used in accordance with the invention are all of the electrically conductive substrates customarily employed and known to the skilled person. The electrically conductive substrates used in accordance with the invention are preferably selected from the group consisting of steel, preferably steel selected from the group consisting of cold-rolled steel, galvanized steel such as dip-galvanized steel, alloy-galvanized steel, aluminized steel and of aluminum and magnesium; particular suitability is possessed by galvanized steel, aluminized steel, and aluminum. Particularly suitable substrates here are parts of bodies or complete bodies of automobiles for production. Before the respective electrically conductive substrate is employed in the method of the invention, the substrate is preferably cleaned and/or degreased.

The electrically conductive substrate used in accordance with the invention may be a substrate pretreated with at least one metal phosphate. Such pretreatment by means of phosphating, which takes place customarily after the substrate has been cleaned and before it is dip coated, is more particularly a pretreatment step which is customary within the automobile industry. It is a specific object of the present invention, however, to make it possible to do away with such phosphating pretreatment of the electrically conductive substrate for at least partial coating, with a metal phosphate such as zinc phosphate, for example. In one preferred embodiment in the method of the invention, therefore, there is no such phosphating step, especially not before step (1) of the method of the invention is implemented. Accordingly, the method of the invention preferably features no step of pretreatment with at least one metal phosphate to be carried out before step (1) of the method of the invention.

### Step (0)

In one preferred embodiment, the method of the invention comprises a step (0), which is carried out preferably before step (1), this step comprising
(0) pretreatment of the electrically conductive substrate with an aqueous pretreatment composition (B) comprising
   (B1) at least one water-soluble compound which contains at least one Ti atom and/or at least one Zr atom, and
   (B2) at least one water-soluble compound which contains at least one fluorine atom, as a source of fluoride ions,
      or with an aqueous pretreatment composition (B) which comprises a water-soluble compound which is obtainable by reaction of at least one water-soluble compound which contains at least one Ti atom and/or at least one Zr atom with at least one water-soluble compound which contains at least one fluorine atom, as a source of fluoride ions.

The at least one Ti atom and/or the at least one Zr atom here preferably have the +4 oxidation state. By virtue of the components (B1) and (B2) present therein, and preferably, in addition, by virtue of the correspondingly selected proportions of these components (B1) and (B2), the aqueous pretreatment composition (B) preferably comprises a fluoro complex such as, for example, a hexafluorometallate, i.e., more particularly hexafluorotitanate and/or at least one hexafluorozirconate. The pretreatment composition (B) preferably has a total concentration of the elements Ti and/or Zr which is not below 2.5·10⁻⁴ mol/L, but not greater than 2.0·10⁻² mol/L. The preparation of pretreatment compositions (B) of this kind, and their use in the pretreatment of electrically conductive substrates, are known from WO 2009/115504 A1, for example.

The pretreatment composition (B) preferably further comprises copper ions, preferably copper(II) ions, and also, optionally, one or more water-soluble and/or water-dispersible compounds comprising at least one metal ion selected from the group consisting of Ca, Mg, Al, B, Zn, Mn and W, and also mixtures thereof, preferably at least one aluminosilicate and more particularly one having an atomic ratio of Al to Si atoms of at least 1:3. The preparation of such pretreatment compositions (B), and their use in the pretreatment of electrically conductive substrates, are known from WO 2009/115504 A1, for example. The alumino-silicates are present preferably in the form of nanoparticles having a particle size in the range from 1 to 100 nm as determinable by means of dynamic light scattering. The particle size for such nanoparticles in the range from 1 to 100 nm, as determinable by means of dynamic light scattering, is determined in accordance with DIN ISO 13321.

### Step (1)

Step (1) of the method of the invention, i.e., the at least partial coating of the substrate with a dipping varnish comprising at least one binder, by an at least partial electrophoretic deposition of the dipping varnish on the substrate surface, is accomplished preferably by applying an electrical voltage between the substrate and at least one counterelectrode. Step (1) of the method of the invention is carried out preferably in a dip coating bath. The counterelectrode in this case is located preferably in the dip coating bath. The counterelectrode may optionally also be present separate from the dip coating bath, via an anion exchange membrane permeable to anions, for example. In that case, anions formed during dip coating can be transported away from the varnish through the membrane into the anolyte, thereby making it possible to regulate or keep constant the pH in the dip coating bath.

In step (1) of the method of the invention there is preferably complete coating of the substrate with a dipping varnish comprising at least one binder, by complete electrophoretic deposition of the dipping varnish over the entire substrate surface.

In step (1) of the method of the invention a substrate for at least partial coating is introduced at least partially, preferably completely, into a dip coating bath, and step (1) is carried out in this dip coating bath.

In step (1) of the method of the invention there is at least partial coating of the substrate by means of at least partial electrophoretic deposition of a dipping varnish. The dipping varnish is therefore an electrodeposition primer. The electrodeposition primer used may be either a cathodically electrodepositable primer or an anodically electrodepositable primer. The skilled person knows of such electrodeposition primers. The dipping varnish is preferably a cathodically depositable electrodeposition primer.

The dipping varnish is preferably contacted with an electrically conducting anode and with the electrically conductive substrate connected as cathode. Alternatively, however, the dipping varnish need not be brought directly into contact with an electrically conducting anode, if the anode, for example, is present separate from the dip coating bath, via an anion-permeable anion exchange membrane, for example.

Passage of electrical current between anode and cathode is accompanied by the deposition on the cathode—that is—on the substrate—of a firmly adhering coating film. The applied voltage lies preferably in a range from 50 to 500 volts.

Step (1) of the method of the invention is conducted preferably at a dipping bath temperature in a range from 20 to 45° C., more preferably in a range from 22 to 42° C., very preferably in a range from 24 to 39° C., especially preferably in a range from 26 to 36° C., with more particular preference in a range from 27 to 33° C. such as, for example, in a range from 28 to 30° C. In another preferred embodiment of the method of the invention, step (1) is conducted at a dipping bath temperature of not more than 40° C., more preferably not more than 38° C., very preferably not more than 35° C., especially preferably not more than 34° C. or not more than 33° C. or not more than 32° C. or not more than 31° C. or not more than 30° C. or not more than 29° C. or not more than 28° C. In a further other preferred embodiment of the method of the invention, step (1) is conducted at a dipping bath temperature δ32° C. such as, for example, δ31° C. or δ30° C. or δ29° C. or δ28° C. or δ27° C. or δ26° C. or δ25° C. or δ24° C. or δ23° C.

The dipping varnish used in accordance with the invention is preferably an aqueous dipping varnish.

The dipping varnish used in accordance with the invention comprises at least one binder. The binder used in accordance with the invention is preferably a binder in dispersion or solution in water.

All customary binders known to the skilled person are suitable here as a binder component of the dipping varnish used in accordance with the invention.

The dipping varnish preferably comprises at least one binder having reactive functional groups which allow a crosslinking reaction. The binder present in the dipping varnish is a self-crosslinking binder or an externally crosslinking binder, preferably an externally crosslinking binder. In order to allow a crosslinking reaction, therefore, the dipping varnish used in accordance with the invention preferably further comprises at least one crosslinking agent, as well as the at least one binder. The binder is preferably a polymeric resin.

The binder used in the dipping varnish employed in accordance with the invention, or the crosslinking agent optionally present, is preferably thermally crosslinkable. Preferably the binder and the crosslinking agent optionally present are crosslinkable on heating to temperatures above room temperature, i.e., above 18-23° C. Preferably the binder and the crosslinking agent optionally present are crosslinkable only at oven temperatures θ80° C., more preferably θ110° C., very preferably θ130° C., and especially preferably θ140° C. With particular advantage the binder and the crosslinking agent optionally present are crosslinkable at 100 to 250° C., more preferably at 125 to 250° C., and very preferably at 150 to 250° C.

The dipping varnish used in accordance with the invention preferably comprises at least one binder having reactive functional groups which, preferably in combination with at least one crosslinking agent, allow a crosslinking reaction.

Any customary crosslinkable reactive functional group known to the skilled person is contemplated here. Preferably, therefore, the dipping varnish for at least partial deposition, preferably cathodic deposition, on the substrate in step (1) of the method of the invention comprises at least one binder having reactive functional groups selected from the group consisting of optionally substituted primary amino groups, optionally substituted secondary amino groups, optionally substituted tertiary amino groups, hydroxyl groups, thiol groups, carboxyl groups, groups having at least one C═C double bond, such as vinyl groups or (meth)acrylate groups, for example, and epoxide groups; the primary, secondary and tertiary amino groups here may optionally be substituted by one or more—such as two or three, for example—substituents selected in each case independently of one another from the group consisting of C₁₋₆ aliphatic radicals such as, for example, methyl, ethyl, n-propyl, or isopropyl, it being possible for these C₁₋₆ aliphatic radicals to be substituted in turn optionally by 1, 2 or 3 substituents selected in each case independently of one another from the group consisting of OH, NH₂, NH(C₁₋₆ alkyl), and N(C₁₋₆ alkyl)₂. Particularly preferred is at least one binder having reactive functional groups selected from the group consisting of optionally substituted primary amino groups, optionally substituted secondary amino groups, optionally substituted tertiary amino groups, and hydroxyl groups, wherein the primary, secondary, and tertiary amino groups may optionally be substituted by one or more—such as 2 or 3, for example—substituents selected in each case independently of one another from the group consisting of C₁₋₆ aliphatic radicals such as, for example, methyl, ethyl, n-propyl, or isopropyl, it being possible for these C₁₋₆ aliphatic radicals to be substituted in turn optionally by 1, 2 or 3 substituents selected in each case independently of one another from the group consisting of OH, NH₂, NH(C₁₋₆ alkyl) and N(C₁₋₆ alkyl)₂.

The binder present in the dipping varnish used in accordance with the invention is preferably at least one epoxide-based resin, more particularly at least one cationic epoxide-based and amine-modified resin. The preparation of cationic amine-modified, epoxide-based resins of this kind is known and is described in, for example, DE 35 18 732, DE 35 18 770, EP 0 004 090, EP 0 012 463, EP 0 961 797 B1, and EP 0 505 445 B1. Cationic, epoxide-based, amine-modified resins are understood preferably to be reaction products of at least one optionally modified polyepoxide, i.e., of at least one optionally modified compound having two or more epoxide groups, and of at least one preferably water-soluble amine, preferably at least one such primary and/or secondary amine. Particularly preferred polyepoxides here are polyglycidyl ethers of polyphenols, prepared from polyphenols and epihalohydrins. Polyphenols used may be, in particular, bisphenol A and/or bisphenol F. Other suitable polyepoxides are polyglycidyl ethers of polyhydric alcohols, such as of ethylene glycol, diethylene glycol, triethylene glycol, 1,2-propylene glycol, 1,4-propylene glycol, 1,5-pentanediol, 1,2,6-hexane-triol, glycerol, and 2,2-bis(4-hydroxycyclohexyl)-propane. Modified polyepoxides are understood to be those polyepoxides in which some of the reactive functional groups have been reacted with at least one modifying compound. Examples of such modifying compounds are as follows:

a) compounds containing carboxyl groups, such as saturated or unsaturated monocarboxylic acids (e.g., benzoic acid, linseed oil fatty acid, 2-ethylhexanoic acid, Versatic acid), aliphatic, cycloaliphatic and/or aromatic dicarboxylic acids of various chain lengths (e.g., adipic acid, sebacic acid, isophthalic acid, or dimeric fatty acids), hydroxyalkylcarboxylic acids (e.g., lactic acid, dimethylolpropionic acid), and polyesters containing carboxyl groups, or
b) compounds containing amino groups, such as diethylamine or ethylhexylamine or diamines of secondary amino groups, i.e., N,N′-dialkylalkylene-diamines, such as dimethylethylenediamine, N,N′-dialkylpolyoxyalkylenamines, such as N,N′-dimethylpolyoxypropylenediamine, cyanoalkylated alkylenediamines, such as bis-N,N′-cyanoethylethylene-diamine, cyanoalkylated polyoxyalkylenamines, such as bis-N,N′-cyanoethylpolyoxypropylenediamine, polyamino-amides, such as Versamides, for example, more particularly reaction products, containing terminal amino groups, of diamines (e.g., hexamethylenediamine), polycarboxylic acids, more particularly dimer fatty acids, and monocarboxylic acids, more particularly fatty acids, or the reaction product of one mole of diaminohexane with two moles of monoglycidyl ether or monoglycidyl ester, especially glycidyl esters of α-branched fatty acids, such as of Versatic acid, or c) compounds containing hydroxyl groups, such as neopentyl glycol, bisethoxylated neopentyl glycol, neopentyl glycol hydroxypivalate, dimethylhydantoin-N,N′-diethanol, hexane-1,6-diol, hexane-2,5-diol, 1,4-bis(hydroxymethyl)cyclohexane, 1,1-isopropylidene-bis(p-phenoxy)-2-propanol, trimethylolpropane, penta-erythritol, or amino alcohols, such as triethanolamine, methyldiethanolamine, or hydroxyl-containing alkyl ketimines, such as aminomethylpropane-1,3-diol methyl isobutyl ketimine or tris(hydroxymethyl)aminomethane cyclohexanone ketimine, and also polyglycol ethers, polyester polyols, polyether polyols, polycaprolactone polyols, polycaprolactam polyols with various functionalities and molecular weights, or
d) saturated or unsaturated fatty acid methyl esters, which are transesterified in the presence of sodium methoxide with hydroxyl groups of the epoxy resins. Examples of amines which can be used are mono- and dialkylamines, such as methylamine, ethylamine, propylamine, butylamine, dimethylamine, diethylamine, dipropylamine, methylbutylamine, alkanolamines, such as methylethanolamine or diethanolamine, for example, and dialkylaminoalkylamines, such as dimethylaminoethyl-amine, diethylamionpropylamine, or dimethylaminopropyl-amine, for example. The amines which can be employed may also contain other functional groups as well, provided they do not disrupt the reaction of the amine with the epoxide group in the optionally modified polyepoxide, and also do not lead to gelling of the reaction mixture. Secondary amines are used with preference. The charges necessary for dilutability in water and for electrical deposition may be generated by protonation with water-soluble acids (e.g., boric acid, formic acid, acetic acid, lactic acid, preferably acetic acid). A further possibility for the introduction of cationic groups into the optionally modified polyepoxide is to react epoxide groups in the polyepoxide with amine salts.

The dipping varnish used in accordance with the invention preferably comprises at least one crosslinking agent, which allows a crosslinking reaction with the reactive functional groups of the binder in the dipping varnish.

All customary crosslinking agents known to the skilled person may be used, such as phenoplasts, polyfunctional Mannich bases, melamine resins, benzoguanamine resins, and/or blocked polyisocyanates, for example.

One particularly preferred crosslinking agent is a blocked polyisocyanate. Blocked polyisocyanates utilized may be any polyisocyanates such as diisocyanates, for example, in which the isocyanate groups have been reacted with a compound, thereby making the resultant blocked polyisocyanate stable in particular with respect to hydroxyl groups and amino groups such as primary and/or secondary amino groups at room temperature, i.e., at a temperature of 18 to 23° C., but reacting at elevated temperatures, as for example at ≧80° C., more preferably ≧110° C., very preferably ≧130° C., and especially preferably ≧140° C., or at 90° C. to 300° C. or at 100 to 250° C., more preferably at 125 to 250° C., and very preferably at 150 to 250° C.

The blocked polyisocyanates may be prepared using any organic polyisocyanates suitable for crosslinking. Isocyanates employed are preferably (hetero)aliphatic, (hetero)cycloaliphatic, (hetero)aromatic, or (hetero)-aliphatic-(hetero)aromatic isocyanates. Preferred are diisocyanates containing 2 to 36, more particularly 6 to 15, carbon atoms. Preferred examples are 1,2-ethylene diisocyanate, 1,4-tetramethylene diisocyanate, 1,6-hexamethylene diisocyanate (HDI), 2,2,4-(2,4,4)-trimethyl-1,6-hexamethylene diisocyanate (TMDI), diphenylmethane diisocyanate (MDI), 1,9-diisocyanato-5-methylnonane, 1,8-diisocyanato-2,4-dimethyloctane, 1,12-dodecane diisocyanate, ω,ω′-diisocyanatodipropyl ether, cyclobutene 1,3-diisocyanate, cyclohexane 1,3- and 1,4-diisocyanate, 3-isocyanatomethyl-3,5,5-trimethylcyclohexyl isocyanate (isophorone diisocyanate, IPDI), 1,4-diisocyanatomethyl-2,3,5,6-tetramethylcyclohexane, decahydro-8-methyl-(1,4-methanonaphthalen-2 (or 3), 5-ylenedimethylene diisocyanate, hexahydro-4,7-methanoindan-1 (or 2), 5 (or 6) ylenedimethylene diisocyanate, hexahydro-4,7-methanoindan-1 (or 2), 5 (or 6) ylene diisocyanate, 2,4- and/or 2,6-hexahydrotolylene diisocyanate (H₆-TDI), 2,4- and/or 2,6-toluene diisocyanate (TDI), perhydro-2,4′-diphenylmethane diisocyanate, perhydro-4,4′-diphenylmethane diisocyanate (H₁₂MDI), 4,4′-diisocyanato-3,3′,5,5′-tetramethyldicyclo-hexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetra-methylbenzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, 2,5(2,6)-bis(isocyanatomethyl)bicyclo[2.2.1]heptane (NBDI), and also any mixture of these compounds. Polyisocyanates of higher isocyanate functionality can also be used. Examples of such are trimerized hexamethylene diisocyanate and trimerized isophorone diisocyanate. Also possible, furthermore, is the use of mixtures of polyisocyanates. The organic polyisocyanates contemplated as crosslinking agents for the invention may also be prepolymers, deriving, for example, from a polyol, including a polyether polyol or a polyester polyol. Especially preferred are 2,4-toluene diisocyanate and/or 2,6-toluene diisocyanate (TDI), or isomer mixtures of 2,4-toluene diisocyanate and 2,6-toluene diisocyanate, and/or diphenylmethane diisocyanate (MDI).

For the blocking of the polyisocyanate it is possible with preference to use any suitable aliphatic, cycloaliphatic, or aromatic alkyl monoalcohols. Examples of such are aliphatic alcohols, such as methyl, ethyl, chloroethyl, propyl, butyl, amyl, hexyl, heptyl, octyl, nonyl, 3,3,5-trimethylhexyl, decyl, and lauryl alcohol; cycloaliphatic alcohols, such as cyclo-pentanol and cyclohexanol; and aromatic alkyl alcohols, such as phenyl carbinol and methylphenyl carbinol. Other suitable blocking agents are hydroxylamines, such as ethanolamine, oximes, such as methyl ethyl ketone oxime, acetone oxime, and cyclohexanone oxime, and amines, such as dibutylamine and diisopropylamine.

The crosslinking agent is used preferably in an amount of 5 to 60 wt %, preferably 20 to 40 wt %, based on the total weight of the binder, in the dipping varnish.

The binder present in the dipping varnish preferably has a nonvolatile fraction, i.e., a solids fraction, of to 70 wt %, more preferably of 6 to 55 wt %, very preferably of 7 to 40 wt %, more particularly of 8 to 30 wt %, based in each case on the total weight of the binder. Methods for determining the solids fraction are known to the skilled person. The solids fraction is preferably determined in accordance with DIN EN ISO 3251.

Depending on the desired application, moreover, the dipping varnish may comprise at least one pigment.

A pigment of this kind present in the dipping varnish is preferably selected from the group consisting of organic and inorganic, coloring and extending pigments.

Examples of suitable inorganic coloring pigments are white pigments such as zinc oxide, zinc sulfide, titanium dioxide, antimony oxide, or lithopone; black pigments such as carbon black, iron manganese black, or spinel black; chromatic pigments such as cobalt green or ultramarine green, cobalt blue, ultramarine blue, or manganese blue, ultramarine violet or cobalt violet and manganese violet, red iron oxide, molybdate red, or ultramarine red; brown iron oxide, mixed brown, spinel phases, and corundum phases; or yellow iron oxide, nickel titanium yellow, or bismuth vanadate. Examples of suitable organic coloring pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black. Examples of suitable extending pigments or fillers are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers, or polymer powders; for further details, refer to Römpp Lexikon Lacke and Druckfarben, Georg Thieme Verlag, 1998, pages 250 ff., “Füllstoffe” [fillers].

The pigment content of the dipping varnish provided in accordance with the invention may vary according to the end use and to the nature of the pigments. This content, based on the preferably aqueous dipping varnish provided in accordance with the invention, is preferably 0.1 to 60 wt %, more preferably 1.0 to 50 wt %, very preferably 2.0 to 45 wt %, especially preferably 3.0 to 40 wt %, and more particularly 4.0 to 35 wt %.

Depending on its desired application, the dipping varnish used in accordance with the invention may comprise one or more commonly employed additives. These additives are preferably selected from the group consisting of wetting agents, emulsifiers, dispersants, surface-active compounds such as surfactants, flow control assistants, solubilizers, defoamers, rheological assistants, antioxidants, stabilizers, preferably heat stabilizers, processing stabilizers, and UV and/or light stabilizers, catalysts, fillers, waxes, flexibilizers, plasticizers, and mixtures of the above-stated additives. The additive content may vary very widely according to the end use. This content, based on the dipping varnish provided in accordance with the invention, is preferably 0.1 to 20.0 wt %, more preferably 0.1 to 15.0 wt %, very preferably 0.1 to 10.0 wt %, especially preferably 0.1 to 5.0 wt %, and more particularly 0.1 to 2.5 wt %.

The dipping varnish is preferably applied in step (1) of the method of the invention in such a way that the resulting dipping varnish layer has a dry film thickness in the range from 5 to 40 μm, more preferably from 10 to 30 μm.

### Steps (1a) and (1b)

In one preferred embodiment, the method of the invention further comprises a step (1a), which preferably follows step (1) but is carried out before step (2), this step comprising
(1a) rinsing the substrate obtainable according to step (1) and at least partly coated with the dipping varnish, using water and/or
   using ultrafiltrate.

The term “ultrafiltrate” or “ultrafiltration”, particularly in connection with dip coating, is known to the skilled person and defined in, for example, Römpp Lexikon Lacke and Druckfarben, Georg Thieme Verlag 1998.

Carrying out step (1a) allows the recycling of excess dipping varnish constituents, present on the at least partly coated substrate after step (1), into the dipping varnish bath.

The method of the invention may further comprise an optional step (1b), which preferably follows step (1) or (1a), more preferably step (1a), but is carried out before step (2), this step comprising
(1b) contacting the at least partly coated substrate obtainable according to step (1) or step (1a), preferably according to step (1a), and at least partly coated with the dipping varnish, using water and/or ultrafiltrate, preferably over a duration of 30 seconds up to one hour, more preferably over a duration of 30 seconds up to 30 minutes.

### Step (2)

Step (2) of the method of the invention relates to the contacting of the substrate at least partly coated with a dipping varnish using an aqueous composition, the aqueous composition used in step (2) being an aqueous sol-gel composition, and step (2) taking place prior to curing of the electrophoretically deposited dipping varnish.

Step (2) thus envisages an aftertreatment of the substrate, which has already been at least partly coated with the dipping varnish, using an aqueous sol-gel composition.

The term “contacting” in the context of the present invention refers preferably to the immersion of the substrate at least partly coated with the dipping varnish into the aqueous sol-gel composition used in step (2); squirted or sprayed application of the aqueous sol-gel composition used in step (2) to the substrate at least partly coated with the dipping varnish; or rolling of the aqueous sol-gel composition used in step (2) onto the substrate at least partly coated with the dipping varnish. More particularly, the term “contacting” in the sense of the present invention refers to the immersion of the substrate at least partly coated with the dipping varnish into the aqueous sol-gel composition used in step (2).

Step (2) of the method of the invention is carried out preferably after step (1), or after steps (1), (1a), and (1b). In this case, contacting in step (2) is of the substrate obtainable according to step (1), and at least partly coated with a dipping varnish, with the aqueous composition. If the method of the invention additionally comprises a step (1a), which preferably follows step (1) but is carried out before step (2), then the contacting in step (2) is of the substrate at least partly coated with a dipping varnish, and obtainable according to step (1) and treated by rinsing according to step (1a), with the aqueous composition.

The aqueous composition used in step (2) of the method of the invention preferably has a temperature in the range from 8° C. to 60° C., more preferably in the range from 10° C. to 55° C., very preferably in the range from 12° C. to 50° C., especially preferably in the range from 14° C. to 45° C., more particularly in the range from 15° C. to 40° C. or in the range from 15° C. to 37° C., even more preferably in the range from 17° C. to 35° C., most preferably in the range from 18° C. to 30° C. or in the range from 18° C. to 25° C.

The duration of the contacting according to step (2) of the method of the invention, in other words the duration of the contacting of the substrate, at least partly coated with the dipping varnish, with the aqueous composition, lies preferably in the range from 5 to 1000 seconds, more preferably in the range from 10 to 800 seconds, very preferably in the range from 10 to 600 seconds, even more preferably in the range from 10 to 500 seconds.

In another preferred embodiment, the contacting according to step (2) of the method of the invention takes place over a duration of at least 5 seconds, preferably at least 10 seconds, more preferably at least 15 seconds, more particularly at least 20 seconds, most preferably at least 25 seconds.

The composition used in step (2) of the method of the invention is an aqueous composition.

The term “aqueous” in connection with the aqueous composition or aqueous sol-gel composition used in step (2) of the method of the invention refers preferably to a liquid composition which comprises—as liquid diluent, i.e., as liquid solvent and/or dispersion medium, more particularly as solvent—water as principal component. Optionally, however, the aqueous composition used in accordance with the invention may additionally comprise a fraction of at least one organic solvent, preferably of at least one water-miscible organic solvent. Especially preferred are those preferably water-miscible organic solvents selected from the group consisting of alcohols such as methanol, ethanol, 1-propanol, and 2-propanol, organic carboxylic acids such as formic acid, acetic acid, and propionic acid, ketones such as acetone, and glycols such as ethylene glycol or propylene glycol, and also mixtures thereof. The fraction of these preferably water-miscible organic solvents is preferably not more than 20.0 wt %, more preferably not more than 15.0 wt %, very preferably not more than 10.0 wt %, more particularly not more than 5.0 wt %, even more preferably not more than 2.5 wt %, most preferably not more than 1.0 wt %, based in each case on the total fraction of the liquid diluents—that is, liquid solvents and/or dispersion media, more particularly solvents—present in the aqueous composition used in step (2) of the method of the invention.

The aqueous composition used in step (2) of the method of the invention takes the preferable form of an aqueous solution or aqueous dispersion, more particularly the form of an aqueous solution.

The aqueous composition used in step (2) of the method of the invention has preferably a pH in the range from 2.0 to 10.0, more preferably of in the range from 2.5 to 8.5 or in the range from 2.5 to 8.0, very preferably of in the range from 3.0 to 7.0 or in the range from 3.0 to 6.5 or in the range from 3.0 to 6.0, more particularly in the range from 3.5 to 6.0 or in the range from 3.5 to 5.5, especially preferably in the range from 3.7 to 5.5, most preferably in the range from 3.9 to 5.5 or 4.0 to 5.5. Techniques for setting pH levels in aqueous compositions are known to the skilled person. The setting of the desired pH of the aqueous composition used in step (2) of the method of the invention is accomplished preferably by addition of at least one acid, more preferably of at least one inorganic and/or at least one organic acid. Examples of suitable inorganic acids include hydrochloric acid, sulfuric acid, phosphoric acid and/or nitric acid. An example of a suitable organic acid is acetic acid. With very particular preference, the setting of the desired pH of the aqueous composition used in step (2) of the method of the invention is accomplished by addition of phosphoric acid.

The aqueous composition used in step (2) of the method of the invention is an aqueous sol-gel composition.

The skilled person is aware of the terms “sol-gel composition”, “sol-gel”, and also the preparation of sol-gel compositions and sol-gels, from D. Wang et al., Progress in Organic Coatings 2009, 64, 327-338 or S. Zheng et al., J. Sol-Gel. Sci. Technol. 2010, 54, 174-187, for example.

An aqueous “sol-gel composition” in the sense of the present invention means preferably an aqueous composition prepared by reacting at least one starting compound, which has at least one metal atom and/or semimetal atom such as M¹ and/or M², for example, and has at least two hydrolyzable groups such as two hydrolyzable groups X¹, for example, and which additionally optionally has at least one nonhydrolyzable organic radical such as R¹, for example, with water. The at least two hydrolyzable groups here are preferably each bonded directly to the at least one metal atom and/or at least one semimetal atom present in the at least one starting compound, in each case by means of a single bond.

In the course of this reaction, in a first hydrolysis step, the at least two hydrolyzable groups are eliminated and are replaced within the at least one starting compound by OH groups, thus resulting in the formation of metal-OH bonds or semimetal-OH bonds within the at least one starting compound used in the first step (hydrolysis step). In a second step, there is a condensation of two molecules formed in the first step, by reaction, for example, of one of the metal-OH bonds thus formed in one molecule with one of the metal-OH bonds thus formed in the second molecule, with elimination of water (condensation step). The resulting molecule, having for example at least one metal-O-metal group (or metal-O-semimetal group or semimetal-O-semimetal group) and also a total of at least two hydrolyzable groups, can then be hydrolyzed again and can react analogously with further compounds obtainable in accordance with the first hydrolysis step, with the resulting compound formed analogously being then able to continue reacting correspondingly, leading to the formation of chains and, in particular, of two- or three-dimensional structures. This at least two-step process, comprising at least the first hydrolysis step and at least the second condensation step, is referred to as a sol-gel process or sol-gel technique. Depending on the degree of crosslinking as a result of the condensation, the product is a sol or a gel, and consequently the aqueous composition is referred to as a sol-gel composition. A pure sol composition here means preferably a composition in which the reaction products are present in colloidal solution. A sol composition is characterized by a lower viscosity than a gel composition. A pure gel composition means preferably a composition which is distinguished by a high viscosity and which has a gel structure. The transition from a sol composition to a gel composition is marked preferably by an abrupt increase in the viscosity.

The at least one starting compound needed for preparing the aqueous sol-gel composition used in accordance with the invention is here prepared preferably by stirred incorporation into water of, or addition of water to, the at least one starting compound. This takes place preferably at a temperature which is in the range from 15° C. to 40° C. or in the range from 15° C. to 37° C., more preferably in the range from 17° C. to 35° C., most preferably in the range from 18° C. to 30° C. or in the range from 18° C. to 25° C. To accelerate the preparation of the aqueous sol-gel composition used in accordance with the invention, the preparation may optionally also take place at temperatures higher than 40° C., as for example at a temperature of up to 80° C., i.e., for example in a range from 15° C. to 80° C. The aqueous sol-gel composition thus obtained is preferably left, before being used in step (2) of the method of the invention, for a time in the range of 1-72 hours at a temperature of 18-25° C., to rest.

The at least one starting compound used in preparing the aqueous sol-gel composition, and having at least one metal atom and/or semimetal atom such as M¹ and/or M², for example, and at least two hydrolyzable groups such as at least two hydrolyzable groups X¹, for example, preferably also has at least one nonhydrolyzable organic radical. This nonhydrolyzable organic radical, such as a corresponding radical R¹, for example, is preferably bonded directly to the metal atom and/or semimetal atom present in the at least one starting compound, such as M¹ and/or M², for example, by means of a single bond. In this case, during the at least two-step process comprising at least the first hydrolysis step and at least the second condensation step, chains are formed, and more particularly two- or three-dimensional structures are formed, which have both organic and inorganic groups. In this case, the resulting sol-gel composition may be referred to as an inorganic-organic hybrid sol-gel composition.

The at least one nonhydrolyzable organic radical, such as the radical R¹, for example, optionally comprises at least one reactive functional group which is preferably selected from the group consisting of primary amino groups, secondary amino groups, epoxide groups, thiol groups, isocyanate groups, phosphorus-containing groups such as phosphonate groups, silane groups, which may optionally in turn have at least one nonhydrolyzable organic radical which optionally has at least one reactive functional group, and groups which have an ethylenically unsaturated double bond, such as vinyl groups or (meth)acrylic groups, very preferably selected from the group consisting of primary amino groups, secondary amino groups, epoxide groups, thiol groups, and groups which have an ethylenically unsaturated double bond, such as vinyl groups or (meth)acrylic groups, more particularly selected from the group consisting of primary amino groups and epoxide groups.

The expression “(meth)acrylic” in the sense of the present invention encompasses each of the definitions “methacrylic” and/or “acrylic”.

The expression “nonhydrolyzable organic radical which has at least one reactive functional group” is preferably understood, in connection with a nonhydrolyzable organic radical such as the radical R¹, for example, to mean in the sense of the present invention that the nonhydrolyzable organic radical has at least one such functional group that exhibits reactivity toward the reactive functional groups optionally present in the binder of the dipping varnish and/or toward the reactive functional groups present in the crosslinking agent optionally present in the dipping varnish. Through a reaction of corresponding functional groups, covalent bonds may be formed here.

However, the at least one nonhydrolyzable organic radical, such as the radical R¹, for example, need not necessarily have at least one reactive functional group, but may instead be a nonhydrolyzable organic radical which has no reactive functional group.

The expression “nonhydrolyzable organic radical which has no reactive functional group” is understood preferably in the sense of the present invention, in connection with a nonhydrolyzable organic radical such as the radical R¹, for example, to mean that the nonhydrolyzable organic radical has no such functional group that exhibits reactivity toward the reactive functional groups present optionally in the binder of the dipping varnish and/or to the reactive functional groups present in the crosslinking agent optionally present in the dipping varnish.

A particular feature of a resulting aqueous sol-gel composition—in which the at least one starting compound has not only the at least two hydrolyzable groups such as at least two hydrolyzable groups X¹, for example, but also at least one nonhydrolyzable organic radical such as R¹, for example—is that its preparation process does not give rise to the formation of a colloidal hydroxide or colloidal oxide, which is disclosed in EP 1 510 558 A1 or WO 03/090938 A1, for example, but instead gives rise to an inorganic-organic hybrid sol-gel composition, which can be applied more effectively to the dipping varnish applied in step (1) of the method of the invention than can a colloidal hydroxide or colloidal oxide according to EP 1 510 558 A1 or WO 03/090938 A1, not least because an aqueous sol-gel composition of this kind is capable of film formation and, moreover, is incapable of forming any covalent bonds with binder and optionally crosslinking agent present in the dipping varnish.

In one preferred embodiment the aqueous sol-gel composition used in step (2) is obtainable by reacting

at least two starting compounds, each independently of one another having at least one metal atom and/or semimetal atom such as M¹, for example, and also each independently of one another having at least two hydrolyzable groups such as at least two hydrolyzable groups X¹, for example,
where the at least two hydrolyzable groups are preferably each bonded directly by means of single bonds to the metal atom and/or semimetal atom present in each case in the at least two starting compounds,
   with water,
   where preferably at least one of the at least two starting compounds has not only the at least two hydrolyzable groups but also at least one nonhydrolyzable group, more preferably at least one nonhydrolyzable organic radical such as the radical R¹, for example, and this nonhydrolyzable group is, in particular, attached directly by means of a single bond to the metal atom and/or semimetal atom, such as M¹, that is present in the at least one starting compound, and optionally comprises at least one reactive functional group which is preferably selected from the group consisting of primary amino groups, secondary amino groups, epoxide groups, thiol groups, isocyanate groups, phosphorus-containing groups such as phosphonate groups, silane groups, which may optionally in turn have at least one nonhydrolyzable organic radical which optionally has at least one reactive functional group, and groups which have an ethylenically unsaturated double bond, such as vinyl groups or (meth)acrylic groups, is especially preferably selected from the group consisting of primary amino groups, secondary amino groups, epoxide groups, thiol groups, and groups which have an ethylenically unsaturated double bond, such as vinyl groups or (meth)acrylic groups, more particularly selected from the group consisting of primary amino groups and epoxide groups.

The aqueous sol-gel composition used in step (2) of the method of the invention is preferably obtainable by reaction of at least one compound

(M¹)^{x}(X¹)ₐ(R¹), (A1)

and/or

(M²)^{y}(X²)_{b}(R²)(R³), (A2)

preferably of at least one compound (A1),
with water, wherein
   M¹ and M² each independently of one another are a metal atom or a semimetal atom, with preferably at least one of the variables M¹ and M², more preferably both of the variables M¹ and M², standing for Si,
   X¹ and X² each independently of one another are a hydrolyzable group,
   x is the valence of the metal atom or semimetal atom M¹, preferably in each case +3 or +4,
   y is the valence of the metal atom or semimetal atom M², preferably in each case +3 or +4,
   R¹ is X¹, a nonhydrolyzable organic radical, or is (T)(M¹)^{x}(X¹)_{c} or is (U)[(M¹)^{x}(X¹)_{c}]₂, preferably a nonhydrolyzable organic radical,
   R² is a nonhydrolyzable organic radical,
   R³ is a nonhydrolyzable organic radical, is (T)(M¹)^{x}(X¹)_{c}, is (U)[(M¹)^{x}(X¹)_{c}]₂, is (V)(M²)^{y}(X²)_{d}(R²), or is (W)[(M²)^{y}(X²)_{d}(R²)]₂, preferably a nonhydrolyzable organic radical,
   a is x if R¹ is X¹ or
   a is x−1 if R¹ is a nonhydrolyzable organic radical, is (T)(M¹)^{x}(X¹)_{c} or is (U)[(M¹)^{x}(X¹)_{c}]₂, in each case subject to the proviso that a is at least 2,
   b is y−2,
      subject to the proviso that b is at least 2,
   T, U, V and W in each case independently of one another are a radical which has 1 to 30 carbon atoms and may optionally have up to 10 heteroatoms and heteroatom groups selected from the group consisting of O, S, and N,
   c is x−1, preferably subject to the proviso that c is at least 2, and
   d is y−2, preferably subject to the proviso that d is at least 2,
      with water.

The skilled person is aware of the term “hydrolyzable group”. Any customary hydrolyzable group known to the skilled person, such as X¹ or X², for example, may serve as a constituent of the at least one starting compound used in preparing the aqueous sol-gel composition, more particularly of the at least one component (A1) and/or (A2).

A “hydrolyzable group”, such as the groups X¹ and X², for example, refers in the sense of the present invention preferably to a hydrolyzable group selected from the group consisting of halides, preferably fluorides, chlorides, bromides, and iodides, more particularly fluorides and chlorides, alkoxy groups, preferably alkoxy groups O—R^{a}, in which R^{a} is an optionally C₁₋₆-alkoxy-substituted C₁₋₁₆ aliphatic radical, preferably C₁₋₁₀ aliphatic radical, more preferably C₁₋₆ aliphatic radical, more particularly C₁₋₆ alkyl radical, such as for methyl, ethyl, n-propyl, isopropyl, n-butyl, isobutyl, or tert-butyl, or carboxylate groups, preferably C₁₋₆ carboxylate groups, more particularly carboxylate groups selected from the group consisting of acetate, and very preferably diketonate groups selected from the group consisting of acetylacetonate, acetonylacetonate, and diacetylate.

A “hydrolyzable group”, such as, for example, the groups X¹ and X², refers more preferably to an alkoxy group, preferably an alkoxy group O—R^{a}, in which R^{a} is an optionally C₁₋₆-alkoxy-substituted C₁₋₁₆ aliphatic radical, preferably C₁₋₁₀ aliphatic radical, more preferably C₁₋₆ aliphatic radical, more particularly C₁₋₆ alkyl radical, such as for methyl, ethyl, n-propyl, isopropyl, n-butyl, isobutyl, or tert-butyl.

The skilled person is familiar with the term “valence” in connection with metal atoms or semimetal atoms such as M¹ and M². In the sense of the present invention, the valence preferably denotes the oxidation number of the respective metal atom or semimetal atom such as M¹ and M², for example. Valences for x and y—in each case independently of one another—are preferably +2, +3, and +4, more particularly +3 and +4.

Suitable metal atoms such as M¹ and M², for example, are all customary metal atoms, including transition metal atoms, which may be a constituent of the at least one starting compound, more particularly (A1) and/or (A2), such as Al, Ti, Zr, and Fe, for example, preferably Ti and Zr. Suitable semimetal atoms such as M¹ and M², for example, are all customary semimetal atoms which may be a constituent of the at least one starting compound, more particularly (A1) and/or (A2), such as B and Si, for example, preferably Si.

The metal atoms and semimetal atoms, such as M¹ and M², for example, are preferably selected in each case independently of one another from the group consisting of Al, Ti, Zr, Fe, B, and Si, more preferably from the group consisting of Ti, Zr, and Si, very preferably from the group consisting of Zr and Si. In particular the metal atoms and semimetal atoms such as M¹ and M², for example, each denote Si.

M¹ more particularly is selected from the group consisting of Al, Ti, Zr, Fe, B, and Si, more preferably from the group consisting of Ti, Zr, and Si, very preferably from the group consisting of Zr and Si, and more particularly M¹ is Si. Preferably M² is Si.

The valences x, y, and z of the metal atoms and semimetal atoms such as M¹ and M², for example, are preferably selected such that the metal atoms and semimetal atoms such as M¹ and M², for example, are selected in each case independently of one another from the group consisting of Al³⁺, Ti⁴⁺, Zr⁴⁺, Fe³⁺, Fe⁴⁺, B³⁺, and Si⁴⁺, more preferably from the group consisting of Al³⁺, Ti⁴⁺, Zr⁴⁺, and Si⁴⁺, very preferably from the group consisting of Ti⁴⁺, Zr⁴⁺, and Si⁴⁺, and more particularly are each Si⁴⁺.

The skilled person is aware of the term “nonhydrolyzable organic radical”. Any customary organic radical which is known to the skilled person and is nonhydrolyzable may serve as a constituent of the at least one starting compound used in preparing the aqueous sol-gel composition, more particularly of the at least one component (A1) and/or (A2).

A “nonhydrolyzable organic radical”, in connection for example with the radicals R¹, R², and R³, in each case independently of one another, refers preferably to a nonhydrolyzable organic radical selected from the group consisting of C₁₋₁₀ aliphatic radicals, C₁₋₁₀ heteroaliphatic radicals, C₃₋₁₀ cycloaliphatic radicals, 3-10-membered heterocycloaliphatic radicals, 5-12-membered aryl or heteroaryl radicals, C₃₋₁₀ cycloaliphatic radicals bonded via a C₁₋₆ aliphatic radical, 3-10-membered heterocycloaliphatic radicals bonded via a C₁₋₆ aliphatic radical, 5-12-membered aryl or heteroaryl radicals bonded via a C₁₋₆ aliphatic radical, it being possible for each of these radicals optionally to comprise at least one reactive functional group, provided the bond of the nonhydrolyzable organic radical to the metal atom or semimetal atom such as M¹ and/or M², for example, especially if M¹ and/or M² are each Si, cannot be cleaved hydrolytically under customary reaction conditions known to the skilled person.

The expression “C₁₋₁₀ aliphatic radical” in the sense of this invention encompasses preferably acyclic saturated or unsaturated, preferably saturated, aliphatic hydrocarbon radicals, i.e., C₁₋₁₀ aliphatic radicals which may in each case be branched or unbranched and also unsubstituted or mono- or polysubstituted, having 1 to 10 carbon atoms, i.e., C₁₋₁₀ alkanyls, C₂₋₁₀ alkenyls, and C₂₋₁₀ alkynyls. Alkenyls have at least one C—C double bond, and alkynyls have at least one C—C triple bond. Preference is given to a C₁₋₁₀ aliphatic radical selected from the group which encompasses methyl, ethyl, n-propyl, 2-propyl, n-butyl, isobutyl, sec-butyl, tert-butyl, n-pentyl, isopentyl, neopentyl, n-hexyl, n-heptyl, n-octyl, n-nonyl, and n-decyl.

The expression “C₁₋₁₀ heteroaliphatic radical” in the sense of this invention encompasses preferably C₁₋₁₀ aliphatic radicals in which at least one, alternatively optionally 2 or 3, carbon atom or atoms has or have been replaced by a heteroatom such as N, O, or S or by a heteroatom group such as NH, N(C₁₋₁₀ aliphatic radical), or N(C₁₋₁₀ aliphatic radical)₂.

The expression “C₃₋₁₀ cycloaliphatic radical” in the sense of the invention encompasses preferably cyclic aliphatic (cycloaliphatic) hydrocarbons having 3, 4, 5, 6, 7, 8, 9, or 10 carbon atoms, it being possible for the hydrocarbons to be saturated or unsaturated (but not aromatically), unsubstituted or mono- or polysubstituted. The bonding of the C₃₋₁₀ cycloaliphatic radical to the respective superordinate general structure may take place by any desired and possible ring member of the C₃₋₁₀ cycloaliphatic radical, but is preferably via a carbon atom. The C₃₋₁₀ cycloaliphatic radicals may also be singly or multiply bridged, such as, for example, in the case of adamantyl, bicyclo[2.2.1]heptyl, or bicyclo[2.2.2]octyl. Preference is given to a C₃₋₁₀ cycloaliphatic radical selected from the group which encompasses cyclopropyl, cyclobutyl, cyclopentyl, cyclohexyl, and cycloheptyl. The expression “3-10-membered heterocycloaliphatic radical” encompasses preferably aliphatic saturated or unsaturated (but not aromatic)cycloaliphatic radicals having three to ten, i.e., 3, 4, 5, 6, 7, 8, 9, or 10, ring members, in which at least one, optionally alternatively 2 or 3, carbon atoms has or have been replaced by a heteroatom such as N, O, or S, or by a heteroatom group such as NH, N(C₁₋₁₀-aliphatic radical) or N(C₁₋₁₀-aliphatic radical)₂, it being possible for the ring members to be unsubstituted or mono- or polysubstituted. The bonding to the superordinate general structure may be via any desired and possible ring member of the heterocycloaliphatic radical, but is preferably via a carbon atom. Preference is given to 3-10-membered heterocycloaliphatic radicals from the group encompassing azetidinyl, aziridinyl, azepanyl, azocanyl, diazepanyl, dithiolanyl, dihydroquinolyl, dihydropyrrolyl, dioxanyl, dioxolanyl, dioxepanyl, dihydroindenyl, dihydropyridyl, dihydrofuranyl, dihydroisoquinolyl, dihydroindolinyl, dihydroisoindolyl, imidazolidinyl, isoxazolidinyl, morpholinyl, oxiranyl, oxetanyl, pyrrolidinyl, piperazinyl, 4-methylpiperazinyl, piperidyl, pyrazolidinyl, pyranyl, tetrahydropyrrolyl, tetrahydropyranyl, tetrahydroquinolyl, tetrahydro-isoquinolyl, tetrahydroindolinyl, tetrahydrofuranyl, tetrahydropyridyl, tetrahydrothiophenyl, tetrahydro-pyridoindolyl, tetrahydronaphthyl, tetrahydro-carbolinyl, tetrahydroisoxazolopyridyl, thiazolidinyl, and thiomorpholinyl.

The term “aryl” in the sense of this invention denotes aromatic hydrocarbons having 6 to 12 ring members, preferably 6 ring members, including phenyls and naphthyls. Each aryl radical may be unsubstituted or singly or multiply substituted, it being possible for the aryl substituents to be identical or different and to be in any desired and possible position of the aryl. The bonding of the aryl to the superordinate general structure may be via any desired and possible ring member of the aryl radical. Aryl is selected preferably from the group containing phenyl, 1-naphthyl, and 2-naphthyl.

The term “heteroaryl” stands for a 5- to 12-membered, preferably 5- or 6-membered cyclic aromatic radical which contains at least 1, optionally also 2, 3, 4 or 5 heteroatoms, the heteroatoms being selected each independently of one another from the group S, N, and O, and it being possible for the heteroaryl radical to be unsubstituted or mono- or polysubstituted; in the case of substitution on the heteroaryl, the substituents may be identical or different and may be in any desired and possible position of the heteroaryl. Bonding to the superordinate general structure may be via any desired and possible ring member of the heteroaryl radical. It is preferred for the heteroaryl radical to be selected from the group which encompasses benzofuranyl, benzimidazolyl, benzothienyl, benzothiadiazolyl, benzothiazolyl, benzotriazolyl, benzoxazolyl, benzoxadiazolyl, quinazolinyl, quinoxalinyl, carbazolyl, quinolyl, dibenzofuranyl, dibenzothienyl, furyl (furanyl), imidazolyl, imidazothiazolyl, indazolyl, indolizinyl, indolyl, isoquinolyl, isoxazolyl, isothiazolyl, indolyl, naphthyridinyl, oxazolyl, oxadiazolyl, phenazinyl, phenothiazinyl, phthalazinyl, pyrazolyl, pyridyl (2-pyridyl, 3-pyridyl, 4-pyridyl), pyrrolyl, pyridazinyl, pyrimidinyl, pyrazinyl, purinyl, phenazinyl, thienyl (thiophenyl), triazolyl, tetrazolyl, thiazolyl, thiadiazolyl, or triazinyl.

The expression “C₃-C₁₀ cycloaliphatic radical, 3-10-membered heterocycloaliphatic radical, 5-12-membered aryl or heteroaryl radical bonded via a C₁₋₆ aliphatic radical” means preferably that the stated radicals have the definitions defined above and are each bonded via a C₁₋₆ aliphatic radical to the respective superordinate general structure, it being possible for said aliphatic radical to be branched or unbranched, saturated or unsaturated, and unsubstituted or monosubstituted or polysubstituted.

If a radical or a group such as, for example, the group X¹ within the compound (A1), or a nonhydrolyzable organic radical such as the radicals R² and R³ within the compound (A2), occurs multiply within one molecule, then this radical or this group may in each case have identical or different definitions: if, for example, the group X¹ is O—R^{a}, where R^{a} is a C₁₋₆ aliphatic radical, and if, for example, it occurs a total of three times within the molecule (M¹)^{x}(X¹)ₐ(R¹), then X¹ may, for example, be O—C₂H₅ each of the three times, or may be once O—C₂H₅, once O—CH₃, and once O—C₃H₆. If R² and R³ within (A2) are each a nonhydrolyzable organic radical, then one of these radicals, for example, may have at least one reactive functional group, and the remaining radical may have no reactive functional group.

The radicals T, U, V, and W are, in each case independently of one another, a radical which has 1 to 30 carbon atoms and may optionally have up to 10 heteroatoms and heteroatom groups selected from the group consisting of O, S, and N. These radicals T, U, V, and W may be aliphatic, heteroaliphatic, cycloaliphatic, heterocycloaliphatic, aromatic, or heteroaromatic, and partially (hetero)aromatic radicals as well are possible, i.e., (hetero)aromatic radicals which are substituted by at least one aliphatic, heteroaliphatic, cycloaliphatic and/or heterocycloaliphatic group. To the skilled person it is clear that the radicals T, U, V, and W are divalent or trivalent and function as bridging organic groups between two or three metal and/or semimetal atoms. If, for example, R¹ is (U)[(M¹)^{x}(X¹)_{c}]₂, then U is a trivalent group which bridges a radical (M¹)^{x}(X¹)ₐ with two radicals [(M¹)^{x}(X¹)_{c}].

Within the compound (M¹)^{x}(X¹)ₐ(R¹) used as component (A1), all of the groups X¹ preferably have the same definition; more preferably, all of the groups X¹ within the compound (M¹)^{x}(X¹)ₐ(R¹) used as component (A1) stand for O—R^{a}, where R^{a} is preferably a C₁₋₆ aliphatic radical, more particularly a C₁₋₆ alkyl radical, most preferably wherein R^{a} is methyl, ethyl, n-propyl, isopropyl, n-butyl, isobutyl, or tert-butyl.

Within the compound used as component (A2), all of the groups X² preferably have the same definition; more preferably, all of the groups X² within the compound used as component (A2) stand for O—R^{a}, where R^{a} is a C₁₋₆ aliphatic radical, more particularly a C₁₋₆ alkyl radical, most preferably wherein R³ is methyl, ethyl, n-propyl, isopropyl, n-butyl, isobutyl, or tert-butyl.

With preference
M¹ and M² are selected each independently from one another from the group consisting of Al, Ti, Zr, Fe, B, and Si, more preferably from the group consisting of Al, Ti, Zr, and Si, very preferably from the group consisting of Ti, Zr, and Si, especially preferably from the group consisting of Zr and Si, and most preferably M¹ and M² are each Si,
or M¹ is selected from the group consisting of Al, Ti, Zr, Fe, B, and Si, more preferably selected from the group consisting of Al, Ti, Zr, and Si, very preferably selected from the group consisting of Ti, Zr, and Si, especially preferably selected from the group consisting of Zr and Si, most preferably Si, and M² is Si,
X¹ and X² each independently of one another are an alkoxy group O—R^{a}, where R^{a} is in each case a C₁₋₆ aliphatic radical, preferably a C₁₋₆ alkyl radical, more preferably in which R³ is methyl, ethyl, n-propyl, isopropyl, n-butyl, isobutyl, or tert-butyl.

The aqueous sol-gel composition used in step (2) of the method of the invention is preferably obtainable by reaction of at least one compound (A1) as at least one starting compound, in which R¹ is a nonhydrolyzable organic radical which has at least one reactive functional group selected from the group consisting of primary amino groups, secondary amino groups, epoxide groups, thiol groups, isocyanate groups, phosphorus-containing groups, and groups which have an ethylenically unsaturated double bond,

and optionally at least one further compound (A1), in which R¹ is X¹,
and optionally at least one further compound (A1), in which R¹ is a nonhydrolyzable organic radical which has no reactive functional group,
and optionally at least one compound (A2)

The aqueous sol-gel composition used in step (2) is preferably obtainable by reaction of
at least one compound Si(X¹)₃(R¹) as at least one compound (A1-1),
   where R¹ therein is a nonhydrolyzable organic radical which has at least one reactive functional group selected from the group consisting of primary amino groups, secondary amino groups, epoxide groups, and groups which have an ethylenically unsaturated double bond,
and optionally at least one compound Si(X¹)₄ as at least one further compound (A1-2),
and optionally at least one compound Si(X¹)₃(R¹) as at least one further compound (A1-3),
   where R¹ therein is a nonhydrolyzable organic radical which has no reactive functional group,
and optionally at least one compound Zr(X¹)₄ as at least one further compound (A1-4),
with water.

In one particularly preferred embodiment the aqueous sol-gel composition used in step (2) of the method of the invention is obtainable by reaction of
at least one compound Si(X¹)₃(R¹) as at least one compound (A1-1),
   where R¹ therein is a nonhydrolyzable organic radical which has at least one reactive functional group selected from the group consisting of primary amino groups, secondary amino groups, epoxide groups, and groups which have an ethylenically unsaturated double bond, more particularly at least one epoxide group,
   and where the nonhydrolyzable organic radical is preferably selected from the group consisting of C₁-C₁₀ aliphatic radicals and C₁-C₁₀ heteroaliphatic radicals,
   X¹ is OR^{a} and R^{a} is C₁₋₆-alkyl radical,
and optionally at least one compound Si(X¹)₄ as at least one further compound (A1-2), in which X¹ is OR^{a} and R^{a} is a C₁₋₆ alkyl radical,
and optionally at least one compound Si(X¹)₃(R¹) as at least one further compound (A1-3),
   where R¹ therein is a nonhydrolyzable organic radical which has no reactive functional group,
   and where the nonhydrolyzable organic radical is preferably selected from the group consisting of C₁-C₁₀ aliphatic radicals, C₁-C₁₀ heteroaliphatic radicals, 5-12-membered aryl or heteroaryl radicals, and 5-12-membered aryl or heteroaryl radicals bonded via a C₁₋₆ aliphatic radical,
   and X¹ is OR^{a} and R^{a} is a C₁₋₆ alkyl radical,
and optionally at least one compound Zr(X¹)₄ as at least one further compound (A1-4), in which X¹ is OR^{a} and R^{a} is a C₁₋₆ alkyl radical, with water.

With particular preference the aqueous sol-gel composition used in step (2) is obtainable by reaction of
at least one compound Si(X¹)₃(R¹) as at least one compound (A1-1),
   where R¹ therein is a nonhydrolyzable C₁-C₁₀ aliphatic organic radical which has at least one reactive functional group selected from the group consisting of primary amino groups, secondary amino groups, epoxide groups, and groups which have an ethylenically unsaturated double bond,
   X¹ is OR^{a} and R^{a} is C₁₋₆ alkyl radical,
and optionally at least one compound Si(X¹)₄ as at least one further compound (A1-2),
in which X¹ is OR^{a} and R^{a} is a C₁₋₆ alkyl radical,
and optionally at least one compound Si(X¹)₃(R¹) as at least one further compound (A1-3),
   where R¹ therein is a nonhydrolyzable organic C₁-C₁₀ aliphatic radical which has no reactive functional group,
   and in which the nonhydrolyzable organic radical R¹ is preferably selected from the group consisting of C₁-C₁₀ aliphatic radicals, 5-12-membered aryl or heteroaryl radicals, and 5-12-membered aryl or heteroaryl radicals bonded via a C₁₋₆ aliphatic radical,
   and X¹ is OR^{a} and R^{a} is a C₁₋₆ alkyl radical,
and optionally at least one compound Zr(X¹)₄ as at least one further compound (A1-4), in which X¹ is OR^{a} and R^{a} is a C₁₋₆ alkyl radical,
with water.

Where the aqueous sol-gel composition used in accordance with the invention is prepared using at least three starting compounds, such as, for example, three compounds (A1) different from one another, as for example the compounds designated above as (A1-1), (A1-2), and (A1-3), the relative weight ratio of the components (A1-1), (A1-2), and (A1-3) to one another is situated preferably in a range from 5:1:1 to 1:1:5 or from 5:1:1 to 1:5:1 or from 1:5:1 to 5:1:1 or from 1:5:1 to 1:1:5 or from 1:1:5 to 5:1:1 or from 1:1:5 to 1:5:1.

Where the aqueous sol-gel composition used in accordance with the invention is prepared using at least four starting compounds, such as, for example, four compounds (A1) different from one another, as for example the compounds designated above as (A1-1), (A1-2), (A1-3), and (A1-4), the relative weight ratio of the components (A1-1), (A1-2), and (A1-3) and also (A1-4) to one another is situated preferably in a range from 5:1:1:1 to 1:1:1:5 or from 5:1:1:1 to 1:1:5:1 or from 5:1:1:1 to 1:5:1:1 or from 1:5:1:1 to 5:1:1:1 or from 1:5:1:1 to 1:1:5:1 or from 1:5:1:1 to 1:1:1:5 or from 1:1:5:1 to 5:1:1:1 or from 1:1:5:1 to 1:5:1:1 or from 1:1:5:1 to 1:1:1:5 or from 1:1:1:5 to 5:1:1:1 or from 1:1:1:5 to 1:5:1:1 or from 1:1:1:5 to 1:1:5:1. Suitability for preparing the aqueous sol-gel composition used in step (2) of the method of the invention is possessed by, for example, at least one compound (M¹)^{x}(X¹)ₐ(R¹) as component (A1), in which R¹ has the definition X¹. Examples of such compounds are tetramethoxysilane (TMOS), tetraethoxysilane (TEOS), dimethoxydiethoxysilane, tetrapropoxysilane, tetra-isopropoxysilane, tetrabutoxysilane, titanium tetraiso-propoxide, titanium tetrabutoxide, zirconium tetraiso-propoxide, and zirconium tetrabutoxide.

Suitability for preparing the aqueous sol-gel composition used in step (2) of the method of the invention is possessed by, for example, at least one compound (M¹)^{x}(X¹)ₐ(R¹) as component (A1), in which R¹ is a nonhydrolyzable organic radical, it being possible for the nonhydrolyzable organic radical R¹ to have optionally at least one reactive functional group.

If the nonhydrolyzable organic radical R¹ here has at least one group which comprises a vinyl group as ethylenically unsaturated double bond, then suitability as component (A1) is possessed by, for example, vinyltrimethoxysilane (VTMS), vinyltriethoxysilane, vinyltriisopropoxysilane, vinyltrichlorosilane, vinyl-tris(2-methoxyethoxy)silane, vinyltriacetoxysilane, p-styryltrimethoxysilane, and/or p-styryltriethoxysilane. If the nonhydrolyzable organic radical R¹ here has at least one group which comprises a (meth)acrylic group as ethylenically unsaturated double bond, then suitability as component (A1) is possessed by, for example, γ-(meth)-acryloyloxypropyltrimethoxysilane (MAPTS), γ-(meth)-acryloyloxypropyltriethoxysilane, γ-(meth)acryloyloxy-propyltriisopropoxysilane, β-(meth)acryloyloxyethyl-trimethoxysilane, β-(meth)acryloyloxyethyltriethoxy-silane, β(meth)acryloyloxyethyltriisopropoxysilane, 3-(meth)acryloyloxypropyltriacetoxysilane, (meth)acrylamido-propyltriethoxysilane, (meth)acrylamidopropyltrimethoxy-silane, (meth)acrylamidopropyldimethoxyethoxysilane and/or (meth)acrylamidopropylmethoxydiethoxysilane.

If the nonhydrolyzable organic radical R¹ here has at least one group which comprises an isocyanate group, then suitability as component (A1) is possessed by, for example, γ-isocyanatopropyltriethoxysilane and/or γ-isocyanatopropyltrimethoxysilane.

If the nonhydrolyzable organic radical R¹ here has at least one group which comprises at least one primary and/or secondary amino group, then suitability as component (A1) is possessed by, for example, 3-aminopropyltrimethoxysilane (APS), 3-aminopropyltriethoxysilane, 3-aminopropyltriisopropoxysilane, 2-aminoethyltrimethoxysilane, 2-aminoethyltriethoxysilane, 2-aminoethyltriisopropoxysilane, aminomethyltrimethoxy-silane, aminomethyltriethoxysilane, aminomethyltri-isopropoxysilane, 3-(2-aminoethyl)aminopropyltrimethoxysilane (AEAPS), 3-(2-aminoethyl)aminopropyltriethoxysilane, 3-(2-aminoethyl)aminopropyltriisopropoxysilane, 2-(2-aminoethyl)aminoethyltrimethoxysilane, 2-(2-aminoethyl)aminoethyltriethoxysilane, 2-(2-aminoethyl)aminoethyltriisopropoxysilane, 3-(3-aminopropyl)aminopropyltrimethoxysilane, 3-(3-aminopropyl)aminopropyltriethoxysilane, 3-(3-aminopropyl)aminopropyltriisopropoxysilane, diethylenetriaminopropyltrimethoxysilane, diethylene-triaminopropyltriethoxysilane, N-(n-butyl)-3-aminopropyltrimethoxysilane, N-(n-butyl)-3-aminopropyltriethoxysilane, N-cyclohexylaminomethyltriethoxysilane, N-cyclo-hexylaminomethyltrimethoxysilane, N-ethyl-γ-aminoisobutyl-trimethoxysilane, N-ethyl-γ-aminoisobutyltriethoxysilane, N-(vinylbenzyl)-2-aminoethyl-3-aminopropyltrimethoxysilane hydrochloride, N-phenyl-γ-aminopropyltrimethoxysilane, N-phenyl-γ-aminopropyltriethoxysilane, γ-ureidopropyl-trimethoxysilane, γ-ureidopropyltriethoxysilane, N-methyl-[3-(trimethoxysilyl)propyl]carbamate, and/or N-trimethoxy-silylmethyl-O-methylcarbamate.

If the nonhydrolyzable organic radical R¹ here has at least one group which comprises at least one epoxide group, then suitability as component (A1) is possessed by, for example, 3-glycidyloxypropyltrimethoxysilane (GPTMS), 3-glycidyloxypropyltriethoxysilane, 3-glycidyloxypropyl-triisopropoxysilane, 2-glycidyloxyethyltrimethoxysilane, 2-glycidyloxyethyltriethoxysilane, 2-glycidyloxyethyl-triisopropoxyoxysilane, β-(3,4-epoxycyclohexyl)ethyltrimethoxysilane, and/or β-(3,4-epoxycyclohexyl)ethyltriethoxysilane.

If the nonhydrolyzable organic radical R¹ here has at least one group which comprises at least one thiol group, then suitability as component (A1) is possessed by, for example, 3-mercaptopropyltrimethoxysilane (MPTMS), 3-mercaptopropyltriethoxysilane, 3-mercapto-propyltriisopropoxysilane, 2-mercaptoethyltrimethoxy-silane, 2-mercaptoethyltriethoxysilane and/or 2-mercapto-ethyltriisopropoxysilane.

If the nonhyrolyzable organic radical R¹ here has at least one group which is phosphorus-containing, then suitability as component (A1) is possessed by, for example, dimethylphosphonatoethyltrimethoxysilane, dimethylphosphonatoethyltriethoxysilane (PHS), dimethyl-phosphonatoethyltriisopropoxysilane, diethylphosphonato-ethyltrimethoxysilane, diethylphosphonatoethyltriethoxy-silane (PHS) and/or diethylphosphonatoethyltriiso-propoxysilane.

Suitability for preparing the aqueous sol-gel composition used in step (2) of the method of the invention is possessed, moreover, by at least one compound (M¹)^{x}(X¹)ₐ(R¹) as component (A1), in which R¹ is a nonhydrolyzable organic radical, it being possible for the nonhydrolyzable organic radical R¹ to have no reactive functional group.

If the nonhydrolyzable organic radical R¹ here has no reactive functional group, then suitability as component (A1) is possessed by, for example, methyltrimethoxysilane (MTMS), methyltriethoxysilane (MTES), methyltripropoxy-silane, methyltriisopropoxysilane, ethyltrimethoxysilane, ethyltriethoxysilane, ethyltripropoxysilane, ethyltri-isopropoxysilane, octyltrimethoxysilane, isobutyltri-ethoxysilane, isobutyltrimethoxysilane, octyltriethoxy-silane, hexyltrimethoxysilane, hexyltriethoxysilane, decyltrimethoxysilane, decyltriethoxysilane, hexadecyl-trimethoxysilane, hexadecyltriethoxysilane, isooctyl-trimethoxysilane, isooctyltriethoxysilane, phenyltri-methoxysilane (PHS), phenyltriethoxysilane, phenyl-tripropoxysilane, phenyltriisopropoxysilane, benzyl-trimethoxysilane, benzyltriethoxysilane, benzyltripropoxy-silane, benzyltriisopropoxysilane, octyltrichlorsilane, tridecafluorooctyltriethoxysilane, tridecafluorooctyltri-methoxysilane, 3-octanoylthio-1-propyltriethoxysilane, 3-octanoylthio-1-propyltrimethoxysilane, 3-triethoxysily-N-(1,3-dimethylbutylidenepropylamine, 3-chloropropyltri-methoxysilane and/or 3-chloropropyltriethoxysilane.

Suitability for preparing the aqueous sol-gel composition used in step (2) of the method of the invention is possessed by, for example, at least one compound (M¹)^{x}(X¹)ₐ(R¹) as component (A1), in which R¹ is (T)(M¹)^{x}(X¹)_{c}. Examples of those suitable here include bis(trimethoxysilyl)ethane, bis(triethoxysilyl)ethane, bis-[γ-(triethoxysilyl)propyl]amine, bis-[γ-(trimethoxy-silyl)propyl]amine, bis(triethoxysilylpropyl)tetrasulfide and/or bis(trimethoxysilylpropyl)tetrasulfide.

Suitability for preparing the aqueous sol-gel composition used in step (2) of the method of the invention is possessed by, for example, at least one compound (M¹)^{x}(X¹)ₐ(R¹) as component (A1), in which R¹ is (U)[(M¹)^{x}(X¹)_{c}]₂. Examples of those suitable here include tris[3-(trimethoxysilyl)propyl]isocyanurate.

Suitability for preparing the aqueous sol-gel composition used in step (2) of the method of the invention is possessed by, for example, at least one compound (M²)^{y}(X²)_{b}(R²)(R³) as component (A2), in which R² and R³ independently of one another are each a nonhydrolyzable organic radical. Examples of those suitable here include 3-glycidyloxypropylmethyldiethoxysilane, 3-glycidyloxy-propylmethyldimethoxysilane, γ-(meth)acryloyloxypropyl-methyldimethoxysilane, 3-mercaptopropylmethyldimethoxy-silane, 3-mercaptopropylmethyldiethoxysilane, γ-(meth)-acryloxypropylmethyldiethoxysilane, N-(2-aminoethyl)-3-aminopropylmethyldimethoxysilane, N-(2-aminoethyl)-3-aminopropylmethyldiethoxysilane, 3-aminopropylmethyldiethoxysilane, 3-aminopropylmethyldimethoxysilane, dimethyldimethoxysilane, dimethyldiethoxysilane, di-tert-butoxydiacetoxysilane, vinyldimethoxymethylsilane, vinyldiethoxymethylsilane, N-cyclohexylamino-methylmethyl-diethoxysilane, N-cyclohexylaminomethylmethyldimethoxy-silane, (cyclohexyl)methyldimethoxysilane, dicyclopentyl-dimethoxysilane and/or N-dimethoxy(methyl)silylmethyl-O-methylcarbamate.

In one preferred embodiment of the method of the invention the solids content of the aqueous composition used in step (2) after complete hydrolysis and condensation of the at least one starting compound is in a range from 0.01 up to 10 wt %, more preferably in a range from 0.05 up to 7.5 wt %, very preferably in a range from 0.1 up to 5 wt %, more particularly in a range from 0.2 up to 2 wt % or in a range from 0.2 up to 1 wt %, based in each case on the total weight of the aqueous composition.

This solids content of the aqueous sol-gel composition used in accordance with the invention may be determined by means of calculation from the amount of the at least one starting compound used in preparing the sol-gel composition. Complete hydrolysis of the hydrolysable groups present in the at least one starting compound, such as of the hydrolysable groups X¹, for example, and, furthermore, complete condensation of all of the metal-OH and/or semimetal-OH bonds formed by such complete hydrolysis, such as M¹-OH bonds, for example, is assumed in that case. For the calculation of the solids content of the aqueous sol-gel composition used in accordance with the invention, all of any single bonds present that are formed between a nonhydrolyzable group, such as a nonhydrolyzable organic radical such as R¹, and a metal atom or semimetal atom, such as M¹, are considered to form part of the solids content and are counted accordingly. The solids content of the aqueous sol-gel composition used in accordance with the invention is preferably determined by means of this calculation method—in other words, the solids content specified in connection with the aqueous sol-gel composition used in accordance with the invention is preferably the theoretically calculated solids content of said composition. This theoretically calculated solids content may be calculated for each of the at least one starting compound used in preparing the aqueous sol-gel composition employed in accordance with the invention, in accordance with the general formula

$${SC}_{theo} = \frac{{M}_{cond}}{{M}_{start}} \cdot {fraction}_{formula}$$

in which
SCₜₕₑₒ=theoretically calculated solids content in wt %,
M_{cond}=molar mass of the completely condensed
starting compound, in g/mol,
Mₛₜₐᵣₜ=molar mass of the starting compound, in g/mol, and
fraction_{formula}=fraction of the starting compound
in the composition, in wt %.

An example calculation for determining the theoretically calculated solids content of an aqueous sol-gel composition employed in accordance with the invention is given in section 1 of the experimental part (inventive and comparative examples).

The solids content calculated theoretically in this way is in agreement with a solids content determined according to an experimental method of determination. In this experimental method of determination, the aqueous sol-gel composition employed in accordance with the invention is dried over a time of 60 minutes at a temperature of 130° C. in accordance with DIN EN ISO 3251. The prepared, inventively employed, aqueous sol-gel composition is in this case weighed out in an amount of 2±0.2 g and then dried in accordance with DIN EN ISO 3251.

Where the aqueous sol-gel composition employed in accordance with the invention is prepared using at least two starting compounds such as, for example, two compounds (A1) different from one another—referred to hereinafter as (A1a) and (A1b)—the relative weight ratio of these two components such as (A1a) and (A1b), for example, to one another is in a range from 10:1 to 1:10, more preferably in a range from 7.5:1 to 1:7.5, very preferably in a range from 5:1 to 1:5, more particularly in a range from 2:1 to 1:2.

Where the aqueous sol-gel composition employed in accordance with the invention is prepared using at least three starting compounds such as, for example, three compounds (A1) different from one another—referred to hereinafter as (A1a), (A1b), and (A1c)—the relative weight ratio of the components (A1a) and (A1c) to one another is in a range from 10:1 to 1:10, more preferably in a range from 7.5:1 to 1:7.5, very preferably in a range from 5:1 to 1:5, more particularly in a range from 2:1 to 1:2.

With particular preference the relative weight ratio of component (A1a) to component (A1b) to component (A1c) is in a range from 2±0.2:1±0.2:1±0.2 to 1±0.2:1±0.2:1±0.2 or from 1±0.2:2±0.2:1±0.2 to 1±0.2:1±0.2:1±0.2 or from 1±0.2:1±0.2:2±0.2 to 1±0.2:1±0.2:1±0.2.

The aqueous sol-gel composition may optionally comprise at least one further additive, which is preferably selected from the group consisting of hydrolytically and pyrolytically prepared silica, organic and inorganic nanoparticles, each preferably having a particle size in a range from 1 to 150 nm as determinable by dynamic light scattering in accordance with DIN ISO 13 321, water-soluble or water-dispersible organic polymers, surface-active compounds such as surfactants, emulsifiers, antioxidants, wetting agents, dispersants, flow control assistants, solubilizers, defoamers, stabilizers, preferably heat stabilizers, processing stabilizers, and UV and/or light stabilizers, catalysts, waxes, flexibilizers, flame retardants, reactive diluents, carrier media, resins, adhesion promoters, processing assistants, plasticizers, solids in powder form, solids in fiber form, preferably solids in powder or fiber form selected from the group consisting of fillers, glass fibers, and reinforcing agents, and mixtures of the aforementioned additives. The additive content of the aqueous sol-gel composition employed in accordance with the invention may vary very widely according to the end use. The amount, based in each case on the total weight of the aqueous sol-gel composition employed in accordance with the invention, is preferably 0.1 to 10.0 wt %, more preferably 0.1 to 8.0 wt %, very preferably 0.1 to 6.0 wt %, especially preferably 0.1 to 4.0 wt %, and more particularly 0.1 to 2.0 wt %, and mixtures thereof.

The fractions in wt % of all of the components and additives present in the aqueous sol-gel composition employed in accordance with the invention add up preferably to a total of 100 wt %, based on the total weight of the composition.

The term “encompassing” or “comprising” in the sense of the present invention, such as in connection with the aqueous sol-gel composition employed in accordance with the invention, for example, has, in one preferred embodiment, the definition “consisting of”. In this preferred embodiment, with regard to the aqueous sol-gel composition employed in accordance with the invention, it is possible for one or more of the abovementioned components optionally present in the composition to be present in the composition. All of these components may each be present in their preferred embodiments in the composition.

### Step (2a)

In one preferred embodiment the method of the invention further comprises a step (2a), which preferably follows step (2) but is carried out before an optional step (3), this step comprising
(2a) rinsing the substrate obtainable according to step (2), contacted with the aqueous sol-gel composition and at least partly coated with the dipping varnish, using water and/or ultrafiltrate.

### Step (2b)

In one preferred embodiment the method of the invention further comprises at least one step (2b), which preferably follows step (2a) and/or (2), but is preferably carried out before an optional step (3), this step comprising
(2b) applying at least one further coating film to the substrate obtainable according to step (2) or according to steps (2) and (2a), contacted with the aqueous sol-gel composition and at least partly coated with the dipping varnish.

Step (2b) can be used to apply one or more further coating films to the substrate obtainable according to step (2) or according to steps (2) and (2a), contacted with the aqueous sol-gel composition and at least partly coated with the dipping varnish, and in this case the one or more than one further coating film is applied to the dipping varnish treated according to step (2). If two or more films are to be applied, step (2b) may be repeated with the corresponding frequency. Examples of further coating films for application are, for example, surfacer coats and/or single-layer or multilayer topcoats. After it has been contacted according to step (2) and optionally rinsed with water and/or ultrafiltrate (according to step (2a)), the electrodeposition coating material may be cured, this curing taking place, as described hereinafter, in accordance with a step (3), before a further coat such as a surfacer coat and/or a single-layer or multilayer topcoat is applied. Alternatively, however, the electrodeposition coating material, after having been contacted in accordance with step (2) and subjected to optional rinsing with water and/or ultrafiltrate in accordance with step (2a), may not be cured, with the application instead first of a further coat such as a surfacer coat and/or a single-layer or multilayer topcoat (wet-on-wet method). In this case, following application of this or these further coat or coats, the overall system obtained is cured, with this curing taking place as described below in accordance with a step (3).

### Step (3)

In one preferred embodiment the method of the invention further comprises at least one step (3), which preferably follows step (2) or steps (2) and (2a), and also, in each case optionally, (2b), this step comprising
(3) curing the at least partial coating on the substrate, obtained according to step (2) or according to step (2) and (2a) and also in each case optionally after at least one step (2b).

Step (3) of the method of the invention is carried out preferably by means of baking after step (2) and optionally after at least one further step (2a) and/or (2b). Step (3) takes place preferably in an oven. This curing takes place preferably at an oven temperature in the range from 140° C. to 200° C., more preferably in a range from 150° C. to 190° C., very preferably in a range from 160° C. to 180° C.

The present invention relates, furthermore, to an at least partly coated electrically conductive substrate obtainable in accordance with the method of the invention, such as an at least partly coated metal strip or an at least partly coated metallic component. Such components may be, for example, vehicle bodies and their components for automobiles such as cars, trucks, motorcycles, and buses, and components of electrical household products, or else components from the area of instrument casings, architectural facings, ceiling linings, or window profiles.

The present invention further relates to a component, preferably a metallic component, produced from at least one electrically conductive at least partly coated substrate obtainable in accordance with the method of the invention.

At the upper boundary of the dip coating layer, which is applied electrophoretically and at least partially, components produced with the method of the invention preferably have a region in which there is an accumulation of metal and/or semimetal atoms present in the aqueous sol-gel composition employed, these atoms being detectable on the surface and/or in the cross-section by energy-dispersive X-ray spectroscopy (EDX), or on the surface using X-ray photoelectron spectroscopy (XPS).

A further aspect of the present invention is the use of an aqueous sol-gel composition for aftertreating a dipping varnish layer applied at least partly to an electrically conductive substrate by an at least partial electrophoretic deposition, the aftertreatment taking place by contacting of the dipping varnish layer with the aqueous sol-gel composition.

All of the preferred embodiments described above herein in connection with the use of the aqueous sol-gel composition employed in step (2) of the method of the invention are also preferred embodiments of the aqueous sol-gel composition in the context of its use for aftertreating a dipping varnish layer applied at least partly to an electrically conductive substrate by an at least partial electrophoretic deposition, this aftertreatment taking place by contacting of the dipping varnish layer with the aqueous sol-gel composition. The inventive use here takes place preferably prior to curing of the electrophoretically deposited dipping varnish.

### Determination Methods

### 1. Cross-Cut Testing to DIN EN ISO 2409

The cross-cut test is used to ascertain the strength of adhesion of a coating on a substrate. In accordance with DIN EN ISO 2409, the cross-cut test is carried out for cold-rolled steel (CRS) and hot-dip-galvanized steel (HDG) as electrically conductive substrates, coated by the method of the invention or by a comparative method. This cross-cut testing is carried out both before and after a DIN EN ISO 6270-2 constant condensation conditions test. In this test, the samples under investigation are exposed to an atmosphere at 40° C. and 100% humidity in a constant condensation conditions testing chamber continuously (CH) over a duration of 240 hours. Assessment takes place on the basis of characteristic cross-cut values in the range from 0 (very good adhesion) to 5 (very poor adhesion).

### 2. Copper-Accelerated Acetic Acid Salt Spray Mist Testing to DIN EN ISO 9227 CASS

The copper-accelerated acetic acid salt spray mist test is used for determining the corrosion resistance of a coating on a substrate. In accordance with DIN EN ISO 9227 CASS, the copper-accelerated acetic acid salt spray mist test is carried out for aluminum (AA6014 (ALU)) as electrically conductive substrate, coated by the method of the invention or by a comparative method. In this test, the samples under analysis are in a chamber in which there is continuous misting of a 5% strength common salt solution, the salt solution being admixed with copper chloride and acetic acid, at a temperature of 50° C. over a duration of 240 hours, with controlled pH. The spray mist deposits on the samples under analysis, covering them with a corrosive film of salt water.

After the copper-accelerated acetic acid salt spray mist test has been carried out to DIN EN ISO 9227 CASS, the samples have their rust level assessed in accordance with DIN EN ISO 4628-3. The assessment is made on the basis of characteristic values in the range from 0 (no rust) to 5 (very high rust level).

If, still prior to the copper-accelerated acetic acid salt spray mist testing to DIN EN ISO 9227 CASS, the coating on the samples for investigation is scored down to the substrate with a blade incision, the samples can be investigated for their level of under-film corrosion in accordance with DIN EN ISO 4628-8, since the substrate corrodes along the score line during the DIN EN ISO 9227 CASS copper-accelerated acetic acid salt spray mist test. As a result of the progressive process of corrosion, the coating is undermined to a greater or lesser extent during the test. The extent of undermining in [mm] is a measure of the resistance of the coating.

### 3. Alternating Climate Test

This alternating climate test is used for determining the corrosion resistance of a coating on a substrate. The alternating climate test is carried out for hot-dip-galvanized steel (HDG) as electrically conductive substrate, coated by the method of the invention or by a comparative method. This alternating climate test is carried out in 30 cycles. Each cycle (24 hours) consists of 4 hours of salt spray mist testing to DIN EN ISO 9227, 4 hours of storage under standard conditions to DIN 50014-23/50-2, including cooling phase, and 16 hours of heat and humidity storage under DIN EN ISO 6270-2 conditions at 40±3° C. and atmospheric humidity of 100%. After every 5 cycles there is a rest period of 48 hours under DIN 50014-23/50-2 standard conditions. 30 cycles correspond accordingly to a duration of 42 days in total.

Both before and after the 30 cycles of the alternating climate test, the coated substrates are subjected to a DIN EN ISO 20567-1 stone chip test, the test being carried out always in each case on one particular position on the surface of the substrate. The assessment is made on the basis of characteristic values in the range from 0 (best score) to 5 (worst score).

If, still prior to the alternating climate test, the coating on the samples for investigation is scored down to the substrate with a blade incision, the samples can be investigated for their level of under-film corrosion in accordance with DIN EN ISO 4628-8, since the substrate corrodes along the score line during the alternating climate test. As a result of the progressive process of corrosion, the coating is undermined to a greater or lesser extent during the test. The extent of undermining in [mm] is a measure of the resistance of the coating.

The examples which follow serve to elucidate the invention, but should not be construed as imposing any restriction.

Unless stated otherwise, the percentages are in each case percentages by weight.

### INVENTIVE AND COMPARATIVE EXAMPLES

### 1. Preparation of Inventively Employed Aqueous Sol-Gel Compositions

### Aqueous Sol-Gel Composition S1

A mixture of 9.3 g of tetraethoxysilane (TEOS), 9.3 g of methyltriethoxysilane (MTEOS), and 9.3 g of 3-glycidylpropyltrimethoxysilane (GLYMO) is admixed with stirring with 2572.1 g of deionized water adjusted beforehand with phosphoric acid to a pH of 4.0. The resulting solution is stirred at 21° C. for at least 72 hours.

### Aqueous Sol-Gel Composition S2

A mixture of 8.5 g of tetraethoxysilane (TEOS), 8.5 g of methyltriethoxysilane (MTEOS), and 8.5 g of 3-glycidylpropyltrimethoxysilane (GLYMO) is admixed with stirring with 26 g of ethanol and also 2.0 g of zirconium tetrabutoxide (80% in butanol). After 15 minutes of stirring, 720 g of deionized water adjusted beforehand with phosphoric acid to a pH of 4.0 are added to this mixture by peristaltic pump (pumping rate of 0.5 mL/min). Subsequently the mixture is admixed with 1826.5 g of deionized water adjusted beforehand with phosphoric acid to a pH of 4.0. The resulting solution is stirred at 21° C. for at least 72 hours.

Table 1 provides an overview of the aqueous sol-gel compositions S1 and S2.

TABLE 1

| Sol-gel formulation | S1 | S2 |
|---|---|---|
| TEOS/wt % | 0.358 | 0.327 |
| MTEOS/wt % | 0.358 | 0.327 |
| GLYMO/wt % | 0.358 | 0.327 |
| Zirconium tetrabutoxide (80% strength | — | 0.077 |
| in butanol)/wt % | | |
| Deionized water (adjusted with | 98.926 | 97.942 |
| phosphoric acid to pH of 4.0)/wt % | | |
| Ethanol/wt % | — | 1.0 |
| Solids content (calculated)/wt % | 0.518 | 0.499 |

The wt % figures are based on the total weight of the aqueous sol-gel composition.

As is apparent from table 1, the aqueous sol-gel composition S1 has a calculated solids content of 0.518 wt %, based on the total weight of the composition. In the case of S1, this solids content is the sum total of the calculated solids contents of the individual TEOS, MTEOS, and GLYMO components employed.

Determined by way of example below is the theoretically calculated solids content of TEOS (empirical formula C₈H₂₀O₄Si) within S1. This content is calculated using the general formula

$${SC}_{theo} = \frac{{M}_{cond}}{{M}_{start}} \cdot {fraction}_{formula}$$

SCₜₕₑₒ=theoretically calculated solids content of TEOS in Si, in wt %
M_{cond}=60.05 g/mol (molar mass of TEOS in fully condensed form; corresponds to an empirical formula of O(4/2)Si)
Mₛₜₐᵣₜ=208.33 g/mol (molar mass of TEOS)
Fraction_{formula}=0.358 wt % (fraction of TEOS in the composition, in wt %).

This gives a theoretically calculated solids content of 0.103 wt % for TEOS. Analogously, a corresponding calculation can be made for MTEOS and GLYMO. For MTEOS, the theoretically calculated solids content is 0.135 wt %, and for GLYMO it is 0.281 wt %. This gives an overall theoretically calculated solids content of 0.518 wt % for S1 (see table 1).

### 2. Production of Coated Electrically Conductive Substrates by the Inventive Method (Inventive Examples B1-B6) and by Means of a Comparative Method (Comparative Examples C1 to C3; without Step (2))

Three types of a total of nine metal test sheets T1 (cold-rolled steel (CRS)), T2 (hot dip galvanized steel (HDG)), and T3 (aluminum AA6014 (ALU)) are used as examples of electrically conductive substrates (in each case three times T1, T2, and T3).

These sheets are each cleaned by immersion into a bath containing an aqueous solution containing the commercially available products Ridoline 1565-1 (3.0 wt %) and Ridosol 1400-1 (0.3 wt %) from Henkel, and also water (96.7 wt %), at a temperature of 62° C. for a time of 1.5 minutes. This is followed by mechanical cleaning (by brushes) for a time of 1.5 minutes, after which the sheets are again immersed into the bath for a time of 1.5 minutes again.

Immediately following the cleaning procedure, a cathodic dipping varnish (CDV) (amine-modified epoxy resin binder in combination with a blocked isocyanate crosslinker and a pigment paste, from BASF Coatings, available commercially under the name CathoGuard® 800) is applied to each of the cleaned test sheets T1, T2, and T3 (step (1) of the method). The dipping varnish bath here has a temperature of 28° C. The stirring speed is 600 revolutions per minute.

The substrates coated with a dipping varnish in this way are rinsed with deionized water (step (1a) of the method) and stored in a bath containing deionized water for a time of 0 to 20 minutes (optional step (1b) of the method).

After that, a total of six of the substrates T1, T2, and T3 coated with the dipping varnish (in each case two sheets T1, T2, and T3) are immersed into a bath of the aqueous sol-gel composition S1 or S2 for a time of 10 seconds (step (2)). After the 10 seconds, the emersion rate at which the substrates are subsequently withdrawn from the bath again is 400 mm/min. For the remaining three of the total of nine sheets, step (2) was not carried out.

Following step (2), rinsing takes place with deionized water for a time of 20 seconds (step (2a)). The substrate obtained after step (2) is immersed into a bath of deionized water for a time of 20 seconds.

After drying for a time of 5-20 minutes at 50° C. (oven temperature), the resulting coatings are baked at 175° C. (oven temperature) for a time of 25 minutes (step (3)). Table 2 gives an overview of the coated substrates obtained by means of the inventive method.

TABLE 2

| | Inven- | Inven- | Inven- | Inven- | Inven- | Inven- |
|---|---|---|---|---|---|---|
| | tive | tive | tive | tive | tive | tive |
| | example | example | example | example | example | example |
| | B1 | B2 | B3 | B4 | B5 | B6 |
| Substrate | T1 | T2 | T3 | T1 | T2 | T3 |
| | (CRS) | (HDG) | (ALU) | (CRS) | (HDG) | (ALU) |
| Sol-gel | S1 | S1 | S1 | S2 | S2 | S2 |
| composition | | | | | | |
| used in | | | | | | |
| step (2) | | | | | | |
| Total film | 15.5 | 15 | 14.5 | 15 | 14.5 | 14.5 |
| thickness* | | | | | | |
| [μm] | | | | | | |

*total dry film thickness of the coating applied by the overall method to the substrate

In total the above-described inventive method was carried out for six working examples (inventive examples B1 to B6). The method was carried out starting from each of the test sheets T1, T2, and T3, in each case using each aqueous sol-gel composition S1 and S2 in step (2).

Furthermore, comparative methods were carried out starting from each of the test sheets T1, T2, and T3, in which, however, step (2) was not carried out (comparative examples C1, C2, and C3).

Starting from the three types of different test sheets T1, T2, and T3, the method is repeated until a total of 36 coated test sheets obtainable in accordance with the method described above are obtained (in each case 3 sheets C1, C3, B1, B3, B4, and B6, and also in each case 6 sheets C2, B2, and B5).

### 3. Investigation of the Corrosion Control Effect and Other Properties of the Coated Substrates of Inventive Examples B1-B6 and of Comparative Examples C1 to C3

All of the tests below were carried out in accordance with the determination method indicated above and in accordance with the relevant standard. Each value given in table 3 or table 4 is the mean value (with standard deviation) from a determination in triplicate.

As can be seen from tables 3 and 4, the coated substrates of inventive examples 1 to 6, produced by means of the method of the invention, are notable by comparison with the comparative examples, C1 to C3, in particular in that the undermining in [mm] after the alternating climate test (inventive examples B2 and B5 vs. comparative example C2) and, respectively, after the copper-accelerated acetic acid salt spray mist test of DIN EN ISO 9227 CASS (inventive examples B3 and B6 vs. comparative example C3) have been carried out is reduced by up to 50%. Moreover, by comparison with comparative example C3, after the copper-accelerated acetic acid salt spray mist test of DIN EN ISO 9227 CASS has been carried out, inventive examples B3 and B6 exhibit a substantially lower level of surface rust.

TABLE 3

| | Inven- | Inven- | Inven- | Inven- | Inven- | Inven- |
|---|---|---|---|---|---|---|
| | tive | tive | tive | tive | tive | tive |
| | example | example | example | example | example | example |
| | B1 | B2 | B3 | B4 | B5 | B6 |
| Substrate | T1 | T2 | T3 | T1 | T2 | T3 |
| | (CRS) | (HDG) | (ALU) | (CRS) | (HDG) | (ALU) |
| DIN EN ISO 2409 | 1.0 ± 0* | — | — | 1.0 ± 0* | — | — |
| cross-cut test | 1.0 ± 0^{#} | | | 1.0 ± 0^{#} | | |
| for CRS | | | | | | |
| DIN EN ISO 2409 | — | 1.0 ± 0* | — | — | 1.0 ± 0* | — |
| cross-cut test | | 1.0 ± 0^{#} | | | 1.0 ± 0^{#} | |
| for HDG | | | | | | |
| Alternating climate | — | 4.6 ± 0.3⁺ | — | — | 4.1 ± 0.4⁺ | — |
| test, 30 cycles | | 5.0 ± 0^{~} | | | 5.0 ± 0^{~} | |
| for HDG | | | | | | |
| Copper-accelerated | — | — | 1.9 ± 0.5⁺ | — | — | 1.4 ± 0.3⁺ |
| acetic acid salt | | | 1.0 ± 0^{a} | | | 1.0 ± 0^{a} |
| spray mist test | | | | | | |
| (DIN EN ISO 9227 | | | | | | |
| CASS), 240 h | | | | | | |

*= before constant conditions (CH, 240 h, DIN EN ISO 6270)
^{#}= after constant conditions (CH, 240 h, DIN EN ISO 6270)
⁺= undermining [mm] as per DIN EN ISO 4628-8
^{~}= stone chipping as per DIN EN ISO 20567-1
^{a}= surface rust as per DIN EN ISO 4628-3

TABLE 4

| | Comparative | Comparative | Comparative |
|---|---|---|---|
| | example C1 | example C2 | example C3 |
| Substrate | T1 (CRS) | T2 (HDG) | T3 (ALU) |
| DIN EN ISO | 1.5 ± 0.7* | — | — |
| 2409 cross-cut | 1.0 ± 0^{#} | | |
| test for CRS | | | |
| DIN EN ISO | — | 1.0 ± 0* | — |
| 2409 cross-cut | | 1.0 ± 0^{#} | |
| test for HDG | | | |
| Alternating | — | 5.9 ± 0.5⁺ | — |
| climate test, | | 5.0 ± 0^{~} | |
| 30 cycles for | | | |
| HDG | | | |
| Copper- | — | — | 3.7 ± 0.2⁺ |
| accelerated | | | 2.7 ± 1.2^{a} |
| acetic acid | | | |
| salt spray | | | |
| mist test | | | |
| (CASS, DIN EN | | | |
| ISO 9227), | | | |
| 240 h | | | |

*= before constant conditions (CH, 240 h, DIN EN ISO 6270)
^{#}= after constant conditions (CH, 240 h, DIN EN ISO 6270)
⁺= undermining [mm] as per DIN EN ISO 4628-8
^{~}= stone chipping as per DIN EN ISO 20567-1
^{a}= surface rust as per DIN EN ISO 4628-3

1. A method for at least partly coating an electrically conductive substrate, comprising at least the steps of
(1) at least partly coating the substrate with a dipping varnish comprising at least one binder, by at least partial electrophoretic deposition of the dipping varnish on the substrate surface, and
(2) contacting the substrate at least partly coated with the dipping varnish with an aqueous composition,
wherein the aqueous composition used in step (2) is an aqueous sol-gel composition,
wherein the aqueous sol-gel composition used in step (2) is obtained by reacting at least one starting compound which has at least one metal atom and/or semimetal atom and at least two hydrolyzable groups, and which further has at least one nonhydrolyzable organic radical,
with water
and step (2) takes place before curing of the electrophoretically deposited dipping varnish.

2. (canceled)

3. The method as claimed in claim 1, wherein the aqueous sol-gel composition used in step (2) is obtainable by reacting at least one compound
(M¹)^{x}(X¹)ₐ(R¹), (A1)
and/or
(M²)^{y}(X²)_{b}(R²)(R³) (A2)
with water, in which
M¹ and M² each independently of one another are a metal atom or a semimetal atom,
X¹ and X² each independently of one another are a hydrolyzable group,
x is the valence of the metal atom or semimetal atom M¹,
y is the valence of the metal atom or semimetal atom M²,
R¹ is X¹, a nonhydrolyzable organic radical, (T)(M¹)^{x}(X¹), or (U)[(M¹)^{x}(X¹)_{c}]₂,
R² is a nonhydrolyzable organic radical,
R³ is a nonhydrolyzable organic radical, (T)(M¹)^{x}(X¹)_{c}, (U)[(M¹)^{x}(X¹)_{c}]₂, (V)(M²)^{y}(X²)_{d}(R²) or (W)[(M²)^{y}(X²)_{d}(R²)]₂,
a is x if R¹ is X¹ or
a is x−1 if R¹ is a nonhydrolyzable organic radical, (T)(M¹)^{x}(X¹)_{c}, or (U)[(M¹)^{x}(X¹)]₂, in each case with the proviso that a is at least 2,
b is y−2,
with the proviso that b is at least 2,
T, U, V and W in each case independently of one another are each a radical which has 1 to 30 carbon atoms,
c is x−1, and
d is y−2.

4. The method as claimed in claim 3, wherein
X¹ and X² are selected each independently of one another from the group consisting of halides and alkoxy groups O—R^{a}, in which R^{a} in each case is a C₁₋₁₆ aliphatic radical, and
M¹ and M² are selected each independently of one another from the group consisting of Al, Ti, Zr, Fe, B, and Si.

5. The method as claimed in claim 3, wherein the at least one nonhydrolyzable organic radical within the definitions of R¹, R², and R³—in each case independently of one another—is a radical selected from the group consisting of C₁-C₁₀ aliphatic radicals, C₁-C₁₀ heteroaliphatic radicals, C₃-C₁₀ cycloaliphatic radicals, 3-10-membered heterocycloaliphatic radicals, 5-12-membered aryl or heteroaryl radicals, C₃-C₁₀ cycloaliphatic radicals bonded via a C₁-C₆ aliphatic radical, 3-10-membered heterocycloaliphatic radicals bonded via a C₁-C₆ aliphatic radical, 5-12-membered aryl or heteroaryl radicals bonded via a C₁-C₆ aliphatic radical.

6. The method as claimed in claim 3, wherein
at least one compound (A1) is used as at least one starting compound in which R¹ is a nonhydrolyzable organic radical which has at least one reactive functional group selected from the group consisting of primary amino groups, secondary amino groups, epoxide groups, thiol groups, isocyanate groups, phosphorus-containing groups, and groups which have an ethylenically unsaturated double bond.

7. The method as claimed in claim 1, wherein the aqueous sol-gel composition used in step (2) is obtainable by reacting
at least one compound Si(X¹)₃(R¹) as at least one compound (A1),
where R¹ therein is a nonhydrolyzable organic radical which has at least one reactive functional group selected from the group consisting of primary amino groups, secondary amino groups, epoxide groups, and groups which have an ethylenically unsaturated double bond,
with water.

8. The method as claimed in claim 7, wherein the aqueous sol-gel composition used in step (2) is obtainable by reacting at least one compound Si(X¹)₃(R¹) as at least one compound (A1) as defined in claim 7,
and at least one compound Si(X¹)₄ is used as at least one further compound (A1),
and at least one compound Si(X¹)₃(R¹) is used as at least one further compound (A1),
where R¹ therein is a nonhydrolyzable organic C₁-C₁₀ aliphatic radical which has no reactive functional group,
with water.

9. The method as claimed in claim 1, wherein the solids content of the aqueous composition used in step (2), after complete hydrolysis and condensation of the at least one starting compound used for preparing the aqueous composition, is in a range from 0.01 to 10 wt %, based on the total weight of the aqueous composition.

10. The method as claimed in claim 1, wherein the aqueous composition used in step (2) has a pH in the range from 3.0 to 6.0.

11. The method as claimed in claim 1, wherein the method comprises no phosphating step to be carried out before step (1).

12. The method as claimed in claim 1, further comprising a step (3) of
(3) curing the at least partial coating on the substrate that has been obtained according to step (1) and subjected to contacting in accordance with step (2).

13. An at least partly coated substrate obtainable by the method as claimed in claim 1.

14. A component produced from at least one at least partly coated substrate as claimed in claim 13.

15. A method for aftertreating a dipping varnish layer applied at least partly to an electrically conductive substrate by an at least partly electrophoretic deposition, by contacting of the dipping varnish layer with an aqueous sol-gel composition, wherein the aqueous sol-gel composition is obtainable by reacting at least one starting compound which has at least one metal atom and/or semimetal atom and at least two hydrolysable groups, and which further has at least one nonhydrolyzable organic radical, with water.

16. The method as claimed in claim 1, wherein the aqueous sol-gel composition used in step (2) is obtained by reacting
at least one compound Si(X¹)₃(R¹) as at least one compound (A1),
where R¹ therein is a nonhydrolyzable organic radical which has at least one reactive functional group selected from the group consisting of primary amino groups, secondary amino groups, epoxide groups, and groups which have an ethylenically unsaturated double bond,
and at least one compound Si(X¹)₄ as at least one further compound (A1),
and at least one compound Si(X¹)₃(R¹) as at least one further compound (A1),
where R¹ therein is a nonhydrolyzable organic C₁-C₁₀ aliphatic radical which has no reactive functional group,
with water.
